(19) United States
(12) Patent Application Publication
(10) Pub. No.: US 2026/0120032 A1
(43) Pub. Date: Apr. 30, 2026

(54) Emerging Risk Event Detection and Evaluation

(71) Applicant: Aon Global Operations, SE, Singapore Branch, Singapore (SG)

(72) Inventors: Dylan Butler, Dublin 1 (IE); Shane Egan, Dublin 1 (IE); Saikrishna Javvadi, Dublin 1 (IE); Martin McGovern, Dublin 1 (IE); Joanne Daly, Dublin 1 (IE)

(73) Assignee: Aon Global Operations, SE, Singapore Branch, Singapore (SG)

(21) Appl. No.: 19/263,119

(22) Filed: Jul. 8, 2025

Related U.S. Application Data
(60) Provisional application No. 63/668,929, filed on Jul. 9, 2024.

(51) Int. Cl. G06Q 10/0635

(52) U.S. Cl. CPC G06Q 10/0635

(57) ABSTRACT

Automatically collating information from a corpus of publications regarding effects of emerging risks on organizations includes collecting digital resources relevant to an emerging risk event type, analyzing, using natural language classifier(s), the digital resources to identify a set of named-entity values, and, using the set of named-entity values, clustering subsets of the digital resources as belonging to a same event of a set of emerging risk events. For each cluster subset, the systems and methods may include determining counts of named-entity values within each of the digital resources, classifying a depth of information of each digital resource based on the counts, comparing the digital resources according to semantic similarity to define groups of similar digital resources, and, based on the groups and the depth of information of each of the digital resources, selecting a representative set of digital resources.

### RELATED APPLICATIONS

The present application claims the benefit of U.S. Provisional Patent Application No. 63/668,929 entitled “Emerging Risk Event Detection and Evaluation” and filed Jul. 9, 2024, which is hereby incorporated by reference in its entirety.

### BACKGROUND

Emerging risks are rapidly evolving, complex threats that lack the necessary level of understanding and/or established risk mitigation options to effectively prepare for their impact. Examples of emerging risks include trends in wildfire outbreaks, cybersecurity attacks, and health pandemics. Emerging risks can have unprecedented volatility in terms of frequency of events and/or severity of impact. In addition, as these risks are emerging in an era of unparalleled globalization, they are much more interconnected and co-dependent than established risks. These factors make it critical for business organizations, communities, and governments to understand their exposure to these risks and to optimize their risk mitigation accordingly. Emerging risk will change the risk landscape in profound ways. As the understanding of these risks is still relatively immature, understanding of their key risk drivers is limited.

The inventors recognized the need to proactively derive key risk drivers for emerging risks from evolving reports gathered through global publication sources to enhance risk understanding as risk events occur.

Additionally, a subset of these emerging risks leave organizations vulnerable to secondary risk, such as supply chain risk and/or a reputational risk. The COVID pandemic, in particular, brought international attention to the impact emerging risk can have on global supply chains. Additionally, although reputation may be a subjective concept, reputational risk can lead to very real financial losses to organizations, including, in some examples, a loss of client or customer base, a drop in employee morale/increase in employee turnover, and/or loss of financial backing (e.g., drop in stock price, loss of private investors, etc.).

The inventors recognized the need to evaluate potential impact of secondary risks spawned by emerging risk events. Through acknowledging the likelihood of secondary risk stemming from certain emerging risks, an organization may take steps to mitigate the risk potential.

### SUMMARY OF ILLUSTRATIVE EMBODIMENTS

In one aspect, the present disclosure relates to systems and methods for discovering and recording global risk events through automated analysis of publications gathered from global media sources. The publications, for example, may be collected from network-accessible media publication databases. One or more application programming interfaces (APIs) may be used to communicate queries to extract a relevant portion of the publication collection. The publications may include unstructured natural language data in the form of news releases, articles, and other media descriptions of evolving news events.

In some embodiments, the systems and methods for discovering and recording global risk events are configured to extract structured risk-specific information from the unstructured natural language data of a set of media publications. The automated extraction, for example, may provide a technical solution to the technical problem of organizing unstructured natural language data to derive specific features relevant to understanding concepts captured in media coverage of evolving news stories regarding emerging risk events. The automated extraction, in illustration, may be configured to extract the who, what, when, where, and why specific to various types of emerging risk events. One or more artificial intelligence (AI) networks, such as a generative large language model (LLM) (e.g., such as ChatGPT), may be trained and/or fine-tuned to extract unstructured text portions defined using a risk data schema defining types and relationships between event details.

In some embodiments, the systems and methods for discovering and recording global risk events are configured to, prior to extracting the structured risk-specific information from the unstructured natural language data, automatically select a representative subset of a large number of media publications gathered from global publication sources. Artificial intelligence extraction, for example, is costly both in processing resources and in time. To greatly reduce the resources dedicated to risk-specific information extraction from publications, the inventors derived a technical solution for discarding redundant and/or less rich publication contents, resulting in a hundredfold or thousandfold reduction in publications to a subset of representative publications selected both for diversity of contents and richness of contents. The subset of representative publications, for example, may include ten publications selected from a thousand or more publications. The selection process may include applying natural language classifiers to recognizing named-entities within each publication of the thousand or more original set of publications, and quantifying the recognized named-entities to produce a first ranking of publications based on richness of contents. Further, the selection process may include analyzing the original set of publications for semantic similarity, producing groups of the original set of publications based on semantic similarity of contents. Using the grouped, quantified publications, a representative collection may be selected based on both richness of contents and diversity of contents.

In some embodiments, the systems and methods for discovering and recording global risk events are configured to, prior to extracting the structured risk-specific information from the unstructured natural language data, format the unstructured natural language data as vector formatted event details stored to a vector database. The vector formatting, for example, may capture relationships between the named-entities recognized within each publication and unstructured natural language contents surrounding the recognized named-entities. The vector formatting may supply the AI networks with consistently formatted publication data, improving analysis output. Further, the vector formatting may reduce storage requirements for storing the publication data for analysis.

In one aspect, the present disclosure relates to a data model architecture for storing information gleaned from publications gathered from global media sources in a manner supporting detailed analysis for deriving key risk factors. The data model architecture, for example, may include vector-formatted publication contents that are tagged or labeled based on named-entity recognition. Pretrained natural language classifiers may be provided to recognize named-entities within the unstructured publication data in view of specific types or classifications of emerging risk event information. The classifications, in some examples, may include organizational or corporate name(s), location(s), product(s), impact value(s) (e.g., dollar amounts, number of individuals, geographic expanse, etc.), and/or date(s) and/or time(s). In pre-processing the unstructured publication data prior to AI analysis, for example, the systems and methods described herein provide a technical solution to the technical problem of focused and consistent AI analysis of unstructured natural language data.

In one aspect, the present disclosure relates to systems and methods for objectively quantifying the impact of reputational risk associated with emerging risk events. Emerging risk events commonly represent uninsurable or partially insurable risks due to lack of effective risk transfer products and/or a paucity of risk understanding. By objectively quantifying the impact of reputational risk, the systems and methods described herein may track trends in reputational impact, compare behaviors of organizations impacted by various types of emerging risks to derive successful mitigation factors, and/or discover key risk drivers for downstream reputational harm.

Reputational risk impact, in some embodiments, is objectively quantified by determining a longer-term financial impact to an organization resulting from the emerging risk event. A financial snapshot representing the financial status of the organization may be obtained at the point at which public discussion of the emerging risk event is first identified. The financial snapshot, for example, may include at least one stock price. Further, financial data regarding the market in general may be collected for comparative purposes. The financial data may include one or more stock indices or other financial bellwether. The financial data, for example, may represent a geography, industry, and/or business line of the effected organization. The snapshot may be compared to one or more future snapshots to determine whether a change in value of the effected organization deviates from a change in value of the general market status (e.g., stock index, geographical representation, industry representation, business line representation, etc.). The one or more future snapshots, in one example, may be captured at predetermined intervals (e.g., one week, two weeks, three weeks, one month, six weeks, eight weeks, etc.). In another example, at least one of the future snapshots may be captured based on a status of the publicity related to the emerging risk event (e.g., new publications drop to a predetermined percentage of a spike level of publications per time period such as per day).

In some embodiments, publications may be monitored over time for a “spike” in the story line, representing a point at which information has been widely distributed and detailed analysis of the event as it unfolded are available in a portion of the publications. Concurrent with and/or after the spike, publications may be monitored to identify one or more responses by the effected organization to the event. In illustration, public announcement, mitigation techniques, disclosure and assistance of affected partners/clients/customers, and/or additional activities (e.g., shutting down systems, paying ransom to regain data access, etc.), may be described within a portion of the publications that follow the event. The responses may be analyzed in view of the financial impact to identify one or more successful strategies for mitigating reputational impact.

In one aspect, the present disclosure relates to systems and methods for consolidating emerging risk data and presenting detailed analysis of the potential impact of various emerging risks. The presentation may be customized in light of an entity's (e.g., business, community, government, or other organization) unique risk factors. In another example, the presentation may include a consolidated analysis of many emerging risk events that occurred over a period of time (e.g., one month, one quarter, one year, multiple years, etc.).

In some embodiments, the presentation represents a consolidation of at least one type of emerging risk event and/or multiple types of emerging risk events occurring in a particular geographic region, to a particular business sector, and/or to a particular industry. The presentation, for example, may include graphic illustrations regarding relative and/or absolute quantities of emerging risk events by type, geographical region, sector, and/or industry. In another example, the presentation may include value impact comparisons (e.g., absolute and/or relative) demonstrating differentiation in value (e.g., stock price, privately disclosed valuation, etc.) between the time of the impact of the emerging risk event (e.g., prior to or concurrent with public disclosure of the emerging risk event) and after a period of time has elapsed since the risk event (e.g., predetermined time span, time span based on ongoing publicity regarding the emerging risk event, etc.). In a further example, the presentation may include identifying a ranking of the top types of emerging risk events by frequency (e.g., types of natural disaster, product recall, type of cybersecurity event, etc.). Other presentation options are possible.

The foregoing general description of the illustrative embodiments and the following detailed description thereof provide mere examples of various aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. In the drawings:

FIG. 1A is a flow diagram of an example process for identifying emerging risk events;

FIG. 1B is a flow diagram of an example process for gathering entity information regarding emerging risk events;

FIG. 2 is a flow diagram of an example process for analyzing emerging risk event data;

FIG. 3 is a flow diagram of an example process for assessing risk events for potential secondary risk impact;

FIG. 4A through FIG. 4C illustrate a flow chart of an example method for identifying and tracking emerging risk events;

FIG. 5 is a block diagram of example data structures related to emerging risk events;

FIG. 6 is a flow chart of an example method for performing historic trend analyses on reputational risk event data;

FIG. 7A through FIG. 7C illustrate example graphical user interfaces presenting historical analyses of reputational risk events;

FIG. 8A and FIG. 8B illustrate example graphical user interfaces presenting regional analyses of emerging risk events by event type;

FIG. 9 illustrates an example graphical user interface presenting regional analysis of natural catastrophic risk events;

FIG. 10 is a flow diagram of an example process for refining collected publications for use in analyzing emerging risk event data;

FIG. 11 is an example data arrangement illustrating a set of categories of data points that overlap among types of emerging risk;

FIG. 12A and FIG. 12B illustrate a flow chart of an example method for preparing emerging risk publications for analysis; and

FIG. 13A and FIG. 13B illustrate a flow chart of an example method for producing a mapping of child organizations to parent organizations.

### DETAILED DESCRIPTION OF ILLUSTRATIVE EMBODIMENTS

The description set forth below in connection with the coordinating drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

As used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Further, the terms “approximately,” “about,” “proximate,” “minor variation,” and similar terms generally refer to ranges that include the identified value within some margin, such as, in some examples, 20%, 10%, or 5% in certain embodiments, as well as any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

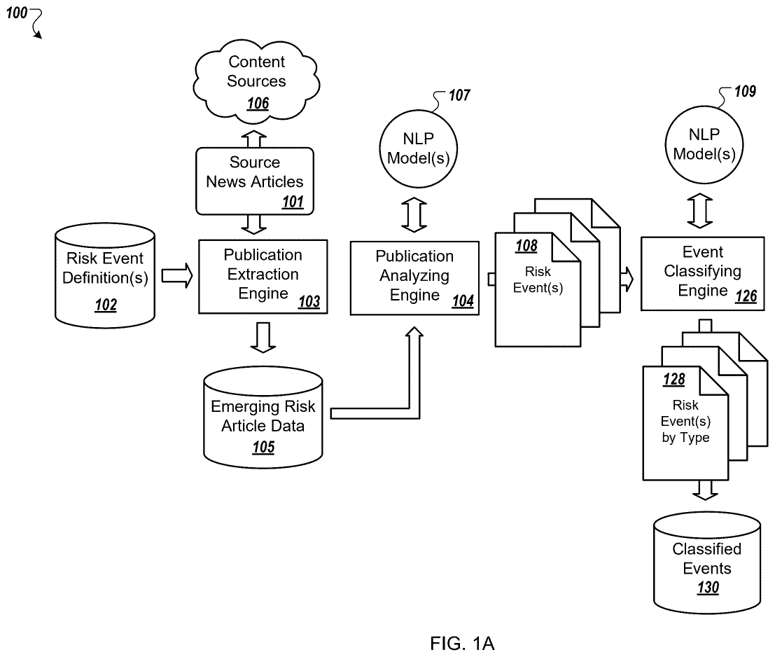

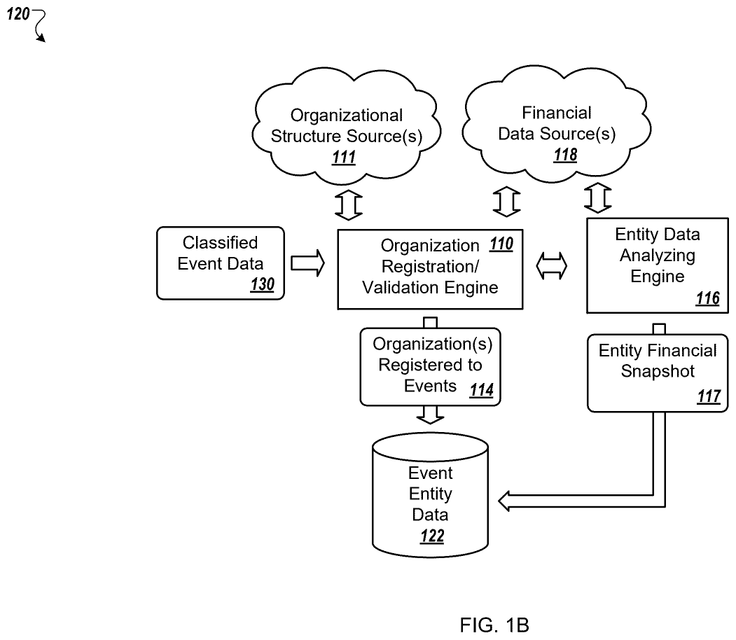

Turning to FIG. 1A, a flow diagram illustrates a process 100 for collecting information regarding emerging risks from media content, and distilling, from the information, data relevant to individual emerging risk events. The process flow 100 may be performed on a periodic basis to identify risk events associated with a variety of risks. In example, the collection of new source news articles may be performed on a first periodic basis (e.g., based on availability of new material for each network-available news source, based on a customized user setting, based on a type of emerging risk event, etc.). The periodic bases may include, in some examples, daily, weekly, monthly, and/or quarterly. The various engines of the process 100, in some embodiments, are configured as software routines or processes (e.g., at least a portion of a software program) coded as instructions for executing on processing circuitry, such as one or more processors. Certain engines or operations performed by certain engines, in some embodiments, are configured as hardware logic (e.g., hardware-based operations) hard-coded or programmed into processing circuitry, such as, in some examples, a programmable logic chip or other programmable logic device, an application-specific integrated circuit (ASIC), or a customized processor device.

In some implementations, a publication extraction engine 103 collects publications (e.g., articles, bulletins, etc.) from a variety of content sources 106 in accordance with risk event definitions 102 corresponding to each risk event type and/or risk event category. The content sources 106, for example, may include breaking news sources such as, in some examples, newspapers, electronic magazines, journal publications, and/or other electronic news circulations containing information regarding risk events. The content sources 106 may vary in type and geographic breadth, in some embodiments, based on the emerging risks being tracked. The emerging risks, in an illustrative example, may include one or more of the following risk categories: environmental risks (e.g., natural disasters such as wildfire, tsunami, tropical cyclone, tornado, storm surge, river flood, hailstorm, flash flood, and/or earthquake, climate events such as permafrost thaws, significant glacial movement, coral reef demise, and/or significant migratory disruptions, etc.); health risks (e.g., pandemics, biological warfare, environmental contaminants, etc.); cybersecurity risks (e.g., data breaches, phishing attacks, ransomware attacks, malware, etc.); and geopolitical risks (e.g., significant currency valuation fluctuations, civil conflict/war, international conflict/war, political polarization, governmental assassination, national debt crises, etc.).

The risk event definitions 102, in some embodiments, include queries and/or artificial intelligence model prompts each designed to define (e.g., focus on the collection of) a particular global emerging risk category or risk type (e.g., classification within a category). The risk event definitions 102, in an illustrative example, may include a separate definition for cyber attacks (and/or types thereof), natural disasters (and/or types thereof), corporate insolvencies, and product recalls.

The publication extraction engine 103, for example, may apply the risk event definitions 102 in one or more search requests from the content sources 106. The search requests, in some examples, may include database queries to one or more databases and/or engineered prompts to one or more artificial intelligence models. In another example, the search requests may be presented to one or more third party data collection services to obtain results from one or more external information source collections. The search requests may collect data from tens of thousands of news outlets in hundreds of countries around the world.

The publication extraction engine 103, in some implementations, queries one or more content sources 106 to capture source news articles 101 related to each of one or more risk definitions 102. The publication extraction engine 103, for example, may obtain at least one set of source news articles 101 for each of the search requests presented to the content sources 106. Each of the source news articles 101, for example, may include a set of data points including a unique data item identifier, a publication source identifier (e.g., news outlet, brokerage report, governmental report, etc.), a content source identifier (e.g., one of the content sources 106), a title, a body of text, one or more images, image metadata, a date and/or timestamp, and/or a category (e.g., news section category such as U.S. politics, business, world events, etc.). Additionally, each data item may include an identifier corresponding to the risk event definition applied to retrieve the data item (e.g., which risk category or sub-category the data item likely belongs to). Further, certain content sources 106 may provide initial classifications along with each emerging risk event data item, such as a taxonomy category, an industry, a geographic region, and/or one or more entities involved in the story captured by the emerging risk event data item. The publication extraction engine 103 may store the source news articles 101 to an emerging risk article data store 105.

In some embodiments, the publication extraction engine 103 stores the source news articles 101 in a table format including a select portion of the descriptive information (e.g., metadata such as publication source, timestamp, category, etc.), such that the information retained is consistent, concise, and capable of efficient extraction for later use. The risk article data store 105, for example, may include a remotely managed data repository having storage enforced by cluster policies established to manage both structured data (e.g., the metadata) and unstructured data (e.g., body text). The data, for example, may be collected into a set of digital storage containers organized to initially group information based in part on certain metadata fields (e.g., date information, classification information, etc.). The data of the risk article data store 105, in some embodiments, is accessible via database query mechanisms.

The publication extraction engine 103, in some implementations, filters the source news articles 101 to reduce a quantity of the content stored as the emerging risk article data of the emerging risk data store 105. For example, the publication extraction engine 103 may remove duplicate articles (e.g., based on title and body word count, based on matching contents to those already stored to the emerging risk data store 105, etc.). In another example, the publication extraction engine 103 may remove unusable articles, such as articles lacking a minimal depth of information, such as a minimum length of body text and/or a minimum title (e.g., a three-sentence breaking news bulletin may be discarded as unusable). In another example, documents may be eliminated based on lack of quality information (e.g., matching patterns of how-to, commentary, and/or summary information). Further, a grammar filter may discard documents lacking well-written information (e.g., incomplete sentences, gibberish, etc.).

In some embodiments, the publication extraction engine 103 augments an existing table with additional information currently collecting as the source news articles 101. For example, while stories are unfolding, data may be collected and combined through adding to a preexisting storage container or cluster (e.g., on an ongoing or periodic basis). In this manner, original data is available for future analysis. In another example, source news articles from multiple sources (e.g., multiple news APIs) may be collected and combined in a single table. In illustration, an initial grouping may be based on similarity of certain metadata fields. In certain embodiments, the publication extraction engine 103 overwrites previously collected data tables. A user may request overwriting as a data refresh, for example.

In some embodiments, upon processing (e.g., by further engines of the process 100 of FIG. 1A and/or the process 120 of FIG. 1B), data may be marked as having been processed. In this manner, upon collection of new data, processed data records may be removed to conserve space. In another example, duplicate/similar information to processed information may be eliminated.

In some implementations, a publication analyzing engine 104 analyzes the emerging risk article data 105 to further categorize and/or arrange the data obtained in the emerging risk article data 105. The publication analyzing engine 104, for example, may validate each source news article 101 of the emerging risk article data 105 as being directed to a risk event corresponding to one of the risk event definitions 102. For example, a portion of the data items in the emerging risk article data 105 may simply relate to one of the risk event definitions 102, such as an article describing a new software platform for assisting organizations in combatting cyber attacks. The publication analyzing engine 104 may analyze each data item of the emerging risk article data 105 to confirm that the data contents are directed to an emerging risk being tracked by the system 100. For example, the article titles may be analyzed in view of one or more trained classifiers to ensure that the title relates to an emerging risk event.

In some implementations, the publication analyzing engine 104 analyzes the emerging risk article data 105 to identify a subject location. In a first example, at least the title of each data item of the emerging risk event data 108 may be analyzed using at least one NLP model and/or AI network 107 to identify a corresponding location impacted by the risk event. The analysis may depend in part on the identification of the type of risk event of the particular data item. For example, for a natural disaster, the event will have a discrete geographic location that is likely identified in the title. Conversely, a cyber attack event may have a wider or less certain region of impact. To identify the location, for example, one or more of the NLP models and/or AI networks 107 may be trained/tuned to identify countries, cities, geopolitical regions (e.g., Asia-Pacific or APAC, the European Union or EU, etc.), and/or other jurisdictions (e.g., Canadian provinces, U.S. states, etc.). Cues within the text content of each data item and/or in a portion of the data item's metadata contents (e.g., geographic region, etc.) may be provided to the NLP model(s) and/or the AI network(s) 107 to further increase confidence in the results obtained.

In some implementations, the publication analyzing engine 104 analyzes the text contents of each data item of the emerging risk article data 105 using one or more natural language processing (NLP) models 107 and/or one or more artificial intelligence networks to identify a subject organization. In a first example, at least the title of each data item of the emerging risk article data 105 may be analyzed using at least one NLP model 107 and/or AI network to identify a corresponding organization (e.g., business name) that is the subject of the article. One or more of the NLP models 107 and/or AI networks, for example, may be trained/tuned to identify types of entities based on contextual cues such as, in some examples, corporate organization terms (e.g., corporation, Corp., LLC, incorporated, Inc., etc.) and/or educational organization terms (e.g., university, college, etc.). In other example, one or more NLP models and/or AI networks 107 may be trained on a language library including major corporate identifiers, such as the names of publicly traded companies. Cues within the text content of each data item and/or in a portion of the data item's metadata contents (e.g., news section category, taxonomy category, industry, geographic region, etc.) may be provided to the NLP model(s) and/or the AI network(s) 107 to further increase confidence in the results obtained.

In some embodiments, the publication analyzing engine 104 filters text of the title and/or body of each news publication using a specialized, pretrained named entity recognition (NER) model configured to recognize a company identifier (e.g., corporate name, stock ticker, etc.) using a bidirectional transformer encoder, such as a BERT-like transformer, one or more subject organizations. The pretrained NER model, unlike a standard NER model which is commonly limited to predefined entities, provides the technical benefit of discovering organization identifiers without the requirement of initial explicit definition. Further, unlike more general intelligent models such as large language models (LLMs), the pretrained NER model is configured to use much fewer storage and processing resources, being both smaller and more efficient than a traditional LLM. Thus, the pretrained NER model provides the technical benefit of discovering organization identifiers in a resource-efficient manner. Initially applying the pretrained NER model, for example, allows for intelligent collection of related articles (at least related by subject organization) prior to expending generative AI resources on detailed analysis, thereby reducing overall cost of processing and increasing speed and efficiency of the processing pipeline illustrated by the process 100 of FIG. 1A. In some embodiments, the publication analyzing engine 104 updates the emerging risk article data 105 using the organization information gleaned through application of the pretrained NER model to initially associate a set of publications based on organization.

In some implementations, the publication analyzing engine 104 performs named entity recognition (NER) on each data item of the emerging risk article data 105 to classify the data item in relation to key subjects of the underlying story. The NER engine, for example, may be a pretrained transformer configured to organize the emerging risk article data 105 according to classifications appropriate to the various types of emerging risk events being monitored. In some embodiments, the publication analyzing engine 104 applies at least one NER engine configured to classify emerging risk articles based on the content of the title. The publication analyzing engine 104 may apply a classification based on meeting or exceeding a threshold confidence level provided by one or more trained classifiers. In illustration, responsive to the NER engine determining it is at least 85% confident that the article pertains to a cyber attack on an organization, the publication analyzing engine 104 may classify the article by the emerging risk type of cyber attack and the organization. The classifications, in some examples, may include organizational or corporate name(s), location(s), product(s), impact value(s) (e.g., dollar amounts, number of individuals, geographic expanse, etc.), and/or date(s) and/or time(s). The publication analyzing engine 104, for example, may identify, by applying the NER classifications to the emerging risk article data 105, a set of risk events 108, each risk event corresponding to a particular article of the source news articles 101.

In some implementations, the publication analyzing engine 104 prompts a generative AI-based NER model using a prompt configured to extract defined data points correlated to a particular emerging risk type from a set of documents (e.g., the emerging risk article data 105 and/or a subset thereof initially categorized based on the organization data identified by the pretrained NER model).

In some implementations, an event classifying engine 126 classifies the risk events 108 by risk type. The risk type, in some embodiments, includes both a primary risk type (e.g., natural disaster, cyber security event, etc.) and, for at least a portion of the risk events 108, a downstream (e.g., secondary) risk type. The downstream risk types may be follow-on risk that stems directly from the risk event, such as, in some examples, reputational risk and/or supply chain risk. The event classifying engine 126, for example, may classify each risk event 108 based at least in part on the primary type of the risk event 108. For example, natural disasters may result in a supply chain disruption but will probably not result in a reputational risk unless the supply chain disruption leads to a painful downstream loss of products and/or services by customers that customers view as having been readily avoided. Conversely, loss of sensitive customer data through a cybersecurity attack will likely leave an organization vulnerable to reputational risk. Thus, the event classifying engine 126 may consider the type of emerging risk, the scope of the risk event 108, and/or any additional circumstances surrounding the risk event 108 in classifying the risk event into one or more risk categories (e.g., a primary risk category and, in some circumstances, a secondary risk category). A portion of the risk events 108 may not be classified under any secondary risk event. The event classifying engine 126 may produce a set of risk events by risk type 128. The event classifying engine 126 may store the set of classified risk events 128 to a classified events data store 130.

Turning to FIG. 1B, a flow diagram 120 illustrates a process flow for gathering entity information regarding emerging risk events. In some implementations, an organization registration/validation engine 110 analyzes the classified event data 130 to register an organization to each emerging risk event. The organization registration/validation engine 110, for example, may match organizational data captured in the classified event data 120 to organization information gleaned from one or more organizational structure sources 111 and/or one or more financial data sources 118 to register the appropriate entity data (e.g., correct spelling, correct full organizational name, correct headquarters information, etc.). The organization registration/validation engine 110, in another example, may enrich the information regarding the entity with additional information captured from the organizational structure source(s) 111 and/or the financial data sources 118. For example, the organization registration/validation engine 110 may match a named entity to a corporate structure (e.g., organizational level) of a larger (e.g., parent, umbrella, etc.) organization. In further examples, stock ticker information, international securities identification number (ISIN) code, and/or financial index membership may be derived from the financial data source(s) 118. The organization registration/validation engine 110 may save organization data registered to events 114 in an event entity data store 122. Although the organizational structure source(s) 111 and the financial data source(s) 118 are illustrated as separate sources, in some embodiments, one or more content sources may reliably provide both organizational structure data and financial data (e.g., Bloomberg L.P.).

In some implementations, the organization registration/validation engine 110 classifies the entity based on geography, sector, and/or industry. The organization registration/validation engine 110, for example, may determine, based on the classified event data 130 for each emerging risk and entity data of the registered entity gathered from the organizational structure source(s) 111 and/or the financial data source(s) 118, the geography, sector, and/or industry for each of the emerging risk events. In the event that the publication extraction engine 103 obtained an initial classification for one or more groupings, the organization registration/validation engine 110 may review the emerging risk article data 105 in view of any initial classification(s) provided by any third-party site (e.g., one of the content sources 106) to make a final determination regarding the geography, industry, and/or sector.

In some implementations, an entity data analyzing engine 116 gathers information from one or more financial data sources 118 to capture an entity financial snapshot 117 for each entity registered to one of the emerging risk events (e.g., of the classified event data 130). The entity financial snapshot 117, for example, may include a current valuation for each organization such as, in some examples, a stock price, recent stock market performance (e.g., past week, past 2 weeks, etc.), and/or most recently reported valuation (e.g., balance sheets, income statements, cash flows, etc.). If applicable, in the event of a large organization spanning multiple geographies, sectors, and/or industries, the entity financial snapshot 117 may include financial data specific to a geography, industry, and/or sector affected by the emerging risk event. Conversely, if the subject entity of a particular emerging risk event is a subsidiary of a publicly traded company, the entity data analyzing engine 116 may alternatively or additionally collect financial data regarding the publicly traded company to evaluate a potential impact to the larger organization as a whole. The determination of which organization(s) to monitor financially within a corporate structure may depend on a number of factors including, in some examples, availability of up-to-date financial information corresponding to the subject entity and/or anticipated impact of financial risk to the larger organization due to the risk event suffered by the subject entity. The entity financial snapshot 117 may be stored to the event entity data 122. The stored data may be timestamped at time of capture to represent a financial snapshot of the organization.

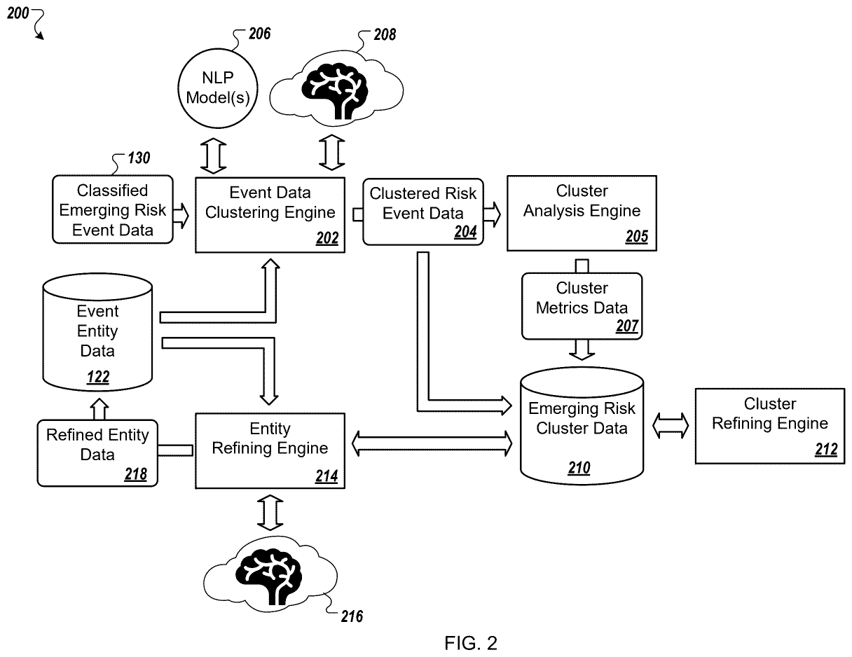

Turning to FIG. 2, a flow diagram illustrates an example process 200 for clustering the emerging risk events represented in the emerging risk event data 108 to identify sets of articles directed to the same risk event. The emerging risk event data 108 may include a large number of data items, including multiple data items directed to a same risk event (e.g., as reported by different news sources, in different news markets and/or geographic regions, building upon an initially breaking story with additional information as the risk event unfolds, etc.). The process 200 may evaluate the large collection of data to extract pertinent information related to each risk event captured therein. In some embodiments, the classified emerging risk event data 130 of FIG. 1A is clustered on the same day that it is captured. In certain embodiments, articles processed into classified emerging risk event data 130 that have been collected over a period of time (e.g., at least two days, three to five days, five days to a week, a week to ten days, eleven days to two weeks) are clustered to capture a more complete story regarding the emerging risk event as the event unfolds and/or more details are learned by the press. In an illustrative example, the classified emerging risk event data 130 may represent event data captured daily over the span of two weeks and processed in accordance with the example process 100 of FIG. 1A and the example process 120 of FIG. 1B.

The various engines of the process 200, in some embodiments, are configured as software routines or processes (e.g., at least a portion of a software program) coded as instructions for executing on processing circuitry, such as one or more processors. Certain engines or operations performed by certain engines, in some embodiments, are configured as hardware logic (e.g., hardware-based operations) hard-coded or programmed into processing circuitry, such as, in some examples, a programmable logic chip or other programmable logic device, an application-specific integrated circuit (ASIC), or a customized processor device.

In some implementations, an event data clustering engine 202 clusters the classified emerging risk event data items 130 by discrete risk event, identifying sets of data items (e.g., processed and formatted articles) containing information related to a same risk event that impacted a same organization. The event data clustering engine 202 may create groupings of classified emerging risk event data items 130 as clustered risk event data 204. Each cluster of the clustered risk event data 204, for example, may be allocated a unique event cluster identifier.

In some implementations, the event data clustering engine 202 analyzes the text contents of each data item of the classified emerging risk event data 130 using one or more natural language processing (NLP) models 206 and/or at least one artificial intelligence network 208. The event data clustering engine 202, in some implementations, generates clustered risk event data 204 clustered (e.g., bucketized, labeled, etc.) by discrete event. The clustered risk event data 204 may be stored to a storage medium for further filtering and/or analysis.

The event data clustering engine 202, in some implementations, transforms one or more of the bulk text portions (e.g., title, abstract, body text, etc.) of each data item of the classified emerging risk event data 130 into a vector format usable by the NLP models 206 and/or AI network 208 for processing. The converted text, for example, may be provided for similarity processing to identify similar articles. In an illustrative example, a cosine similarity model may apply a predefined threshold to matching articles of the classified emerging risk event data 130 based on text similarity.

In some implementations, portions of the classified emerging risk event data 130 are processed by the event data clustering engine 202 for purposes of identifying similar events. For example, based on initial classifications, subsets of the classified emerging risk event data 130 may be determined to be too dissimilar in content for vector-based processing. In illustration, articles pertaining to a same risk event type, in a same general geographic region and/or industry, may be analyzed to capture articles related to the same emerging risk event.

In some implementations, the event data clustering engine 202 evaluates the clustered risk event data 204 for each clustered risk event to combine NER labels and/or refine NER labels (e.g., discard outliers, discard more general descriptors of subjects such as location and/or volume impact for more precise descriptors, etc.) to produce a master set of labeled information pertaining to the risk event.

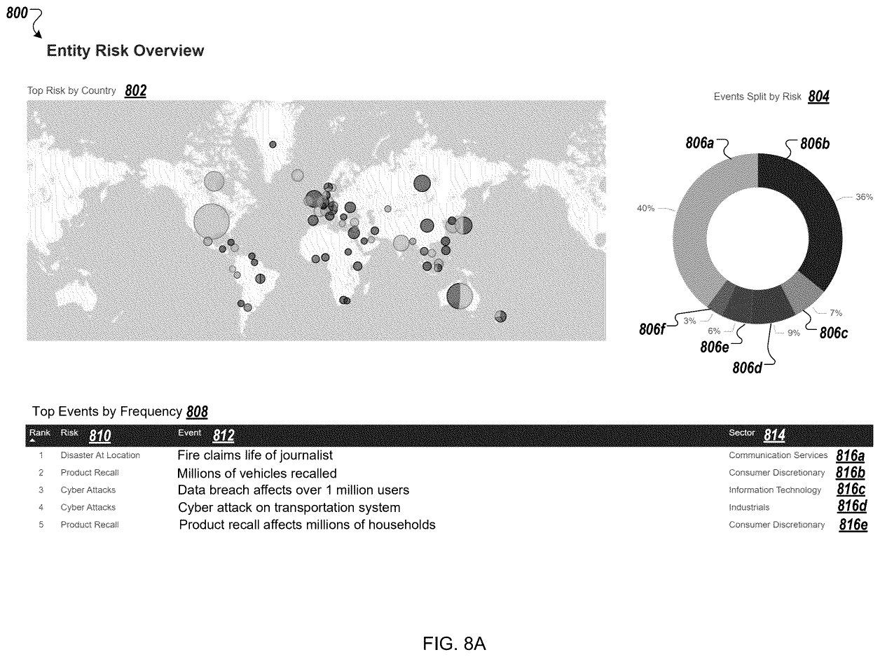

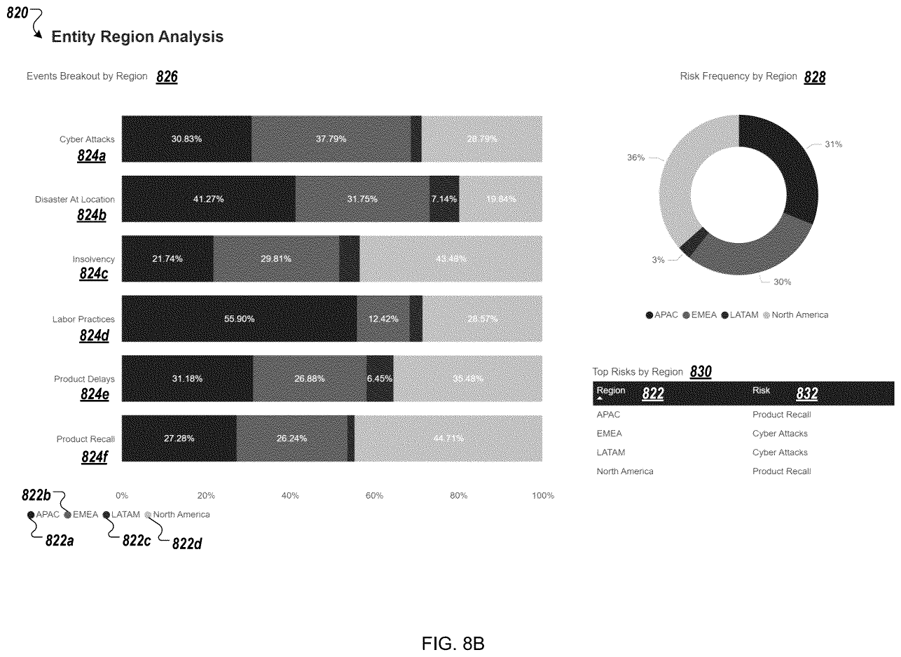

In some implementations, the event data clustering engine 202 automatically produces, from the titles of the set of articles in the cluster, a representative title for the cluster. The representative title, for example, may be used in presenting information to a reviewer related to the emerging risk event. For example, as illustrated in FIG. 8A, the representative title may be illustrated in an event column 812 of an example entity risk overview graphical user interface 800.

The event data clustering engine 202, in some implementations, stores clustered risk event data 204 to an emerging risk cluster data store 210. The emerging risk cluster data 210, for example, may include a cluster identifier, identifiers of each of the emerging risk events of the classified emerging risk event data 130 belonging to the cluster, the emerging risk event type, and the representative title.

In some implementations, a cluster analysis engine 205 analyzes the clustered risk event data 204 for each cluster identified by the event data clustering engine 202 to determine a set of cluster metrics data 207 associated with each clustered emerging risk event. The cluster metrics data 207, for example, may quantify details related to the underlying set of articles captured by each cluster such as, in some examples, a number of stories, lengths of the stories, the timespan of information related to each risk event, and/or the distribution of reporting related to the risk events (e.g., number and/or geographical distribution of news sources reporting on the risk event, etc.). The cluster analysis engine 205 may quantify and/or classify the reporting related to each topic area. In illustration for example purposes only, the number of stories may be quantified as a sum, while the lengths of stories may be classified as “minimally detailed,” “detailed,” and “highly detailed.”

The cluster analysis engine 205, in some embodiments, applies at least one count to each set of clustered data items of the clustered risk event data 204. For example, to assist in objectively quantifying the impact (e.g., scope, severity, etc.) of each emerging risk event, counts of articles related to a particular emerging risk event may be compared to typical counts of articles historically captured in relation to the same type of emerging risk event (or further refined by type of event by industry, type of event by sector, type of event by geographic region, etc.). Further, to quantify the scope of the coverage, sub-counts related to geographic regions of each publication, publication types (e.g., general news, insurance journals, business journals, scientific journals, etc.), and/or publication languages may further provide evidence related to the global interest impact of each event. In another example, to quantify the timeframe of a multi-day event, counts of numbers of articles per day may be captured to determine the most impactful news days for each risk event. Natural disaster events, for example, may involve multiple days of impact related to actual weather events as well as damage to infrastructure and follow-on catastrophic damage (e.g., fires stemming from building damage, etc.). A number of days of “news spikes” (e.g., a notable increase in press related to a particular emerging risk event) may be compared to historic trends, for example, to determine relative scope and/or severity of the subject emerging risk event.

In implementations where articles captured over time are being clustered (e.g., after a threshold number of days have passed), the date of publication of the last article in the cluster may differ than the range of dates of capture of all of the articles in the clustered risk event data 204. For example, the process 200 may be performed two weeks after initial capture of articles in the classified emerging risk event data 130, while press related to a particular risk event may have died off within the span of five or six days. In this circumstance, the cluster analysis engine 205 may determine a start date and an end date related to the publication span of the representative articles within the cluster.

In some implementations, the cluster analysis engine 205 stores the cluster metrics data 207 in correspondence with each cluster of the clustered risk event data 204 in the emerging risk cluster data 210.

A cluster refining engine 212, in some implementations, compares the sets of resultant clusters of the clustered risk event data 204 to determine whether to form a “super cluster.” The cluster refining engine 212, for example, may merge two or more clusters based on a threshold similarity pointing to the two or more clusters actually representing a single emerging risk event. The cluster refining engine 212, for example, may compare the representative title of each cluster of at least a portion of the clusters (e.g., a subset of the clusters related to the same risk event type) to determine whether a threshold similarity exists between clusters. In another example, the cluster refining engine 212 may filter clusters by organization and compare all clusters related to the same organization to determine whether two or more of the clusters appear to belong to the same emerging risk event.

If the cluster refining engine 212 identifies clusters to merge, in some embodiments, the cluster refining engine 212 aggregates cluster metrics data 207 of each clustered risk event of the “super cluster” and stores the aggregate cluster metrics data 207 along with the risk event article identifiers belonging to the merged clustered risk events. The cluster refining engine 212 may create a new cluster identifier for the merged cluster events or reuse the cluster identifier of one of the cluster events merged into the “super cluster.” The representative title of one of the underlying clustered risk events may be applied to the “super cluster” or a new representative title may be created (e.g., through analysis of the representative titles of the set of clustered risk events being merged). The cluster refining engine 212 may store the merged clustered risk events as a new clustered risk event of the emerging risk cluster data 210.

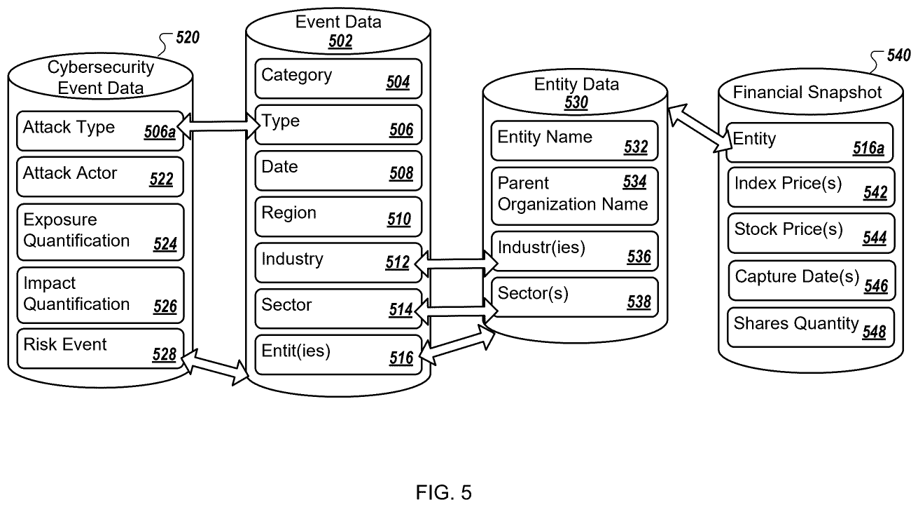

Turning to FIG. 5, for example, the data defining each of the risk events 112 may be organized as event data 502, including an event category 504 (e.g., natural disaster, product recall, cybersecurity attack, etc.), an event type 506 (e.g., for natural disasters, in illustration, a wildfire, tsunami, flood, hurricane, hail storm, wind storm, etc.), an event date 508 (e.g., start date, end date, and/or date range), a region 510 (e.g., geographic location(s)), an industry 512 (e.g., health care, transportation, agriculture, finance, construction, energy, retail, etc.), a sector 514 (e.g., communication services, consumer discretionary, information technology, industrials, etc.), and/or one or more entities 516 (e.g., corporations, governmental organizations, non-profit organizations, etc.).

In some embodiments, for each event type 506, a data organization corresponding to the event type 506 stores data specific to the event type 506. In illustration, a cybersecurity event data structure 520 of FIG. 5 includes an attack type 506a (e.g., data breaches, phishing attacks, ransomware attacks, malware, etc.), an attack actor 522 (e.g., internal, cybercriminal, hacktivist, governmental, etc.), an exposure quantification 524 (e.g., number of systems affected, number of accounts breached, etc.), and an impact quantification 526 (e.g., ransom payment amount, stolen funds, remedial costs, etc.). The cybersecurity event data 520 may include a risk event identifier 528 linking to corresponding event data 502.

Returning to FIG. 2, in some implementations, an entity refining engine 214 is configured to ensure all entities associated with each clustered risk event 210 are represented in a consistent format. For example, typographical errors, stock ticker abbreviations, and/or truncated business names may be converted to a formal representation. Further, in the event of multiple entities, a relationship between entities may be derived (e.g., parent/child company, pre-acquisition name, etc.) to determine a primary entity for each risk event 210.

The entity refining engine 214, in some embodiments, validates the organization(s) associated with the risk events 210 and/or determines a dominant organization (e.g., the organization primarily impacted by the risk event) using one or more artificial intelligence models 216. The AI model(s) 216, for example, may be created to recognize organizational information such as, in some examples, aliases, MIC market codes, stock tickers, and/or parent organizations, using business information collected from a number of third-party data sources. The AI model(s) 216 may provide, in response to the event entity data 122 refined entity data 218 corresponding to one or more of the clustered emerging risk events captured in the emerging risk cluster data 210. Further, the AI model(s) 216 may use additional information regarding the risk events 210 to increase confidence in the identification. In illustration, the geographic region of the risk event may be indicative of whether a parent organization or a child organization is impacted, depending upon where the child organization geographically operates. Further, factors regarding the risk event may be indicative of an industry and/or sector, further refining which organization is being referenced. The refined entity data 218 may be stored to the event entity data 122. Instead of or in addition to updating the event entity data 122, the entity refining engine 214 may update entity data stored with the emerging risk cluster data 210. For example, an incorrect entity identifier stored in relation to a particular clustered risk event may be replaced with a correct entity identifier (e.g., a particular entity data set captured in the event entity data 122). Turning to FIG. 5, an example entity data structure 530 is illustrated. The entity data structure 530 includes an entity name 532, a parent organization name 534, one or more industries 536 relevant to the named entity, and one or more sectors 538 relevant to the named entity.

The entity data structure 530, for example, may include general entity information previously stored and linked to event data corresponding, potentially, to multiple past risk events in addition to a present emerging risk event. For example, as illustrated, the event data 502 may include entity identifiers(s) 516 linking to one or more entity data structures 530, where the particular industry 512 of potentially multiple industries 536 and/or a particular sector 514 of potentially multiple sectors 538 relevant to the particular risk event corresponding to the event data 502 are identified.

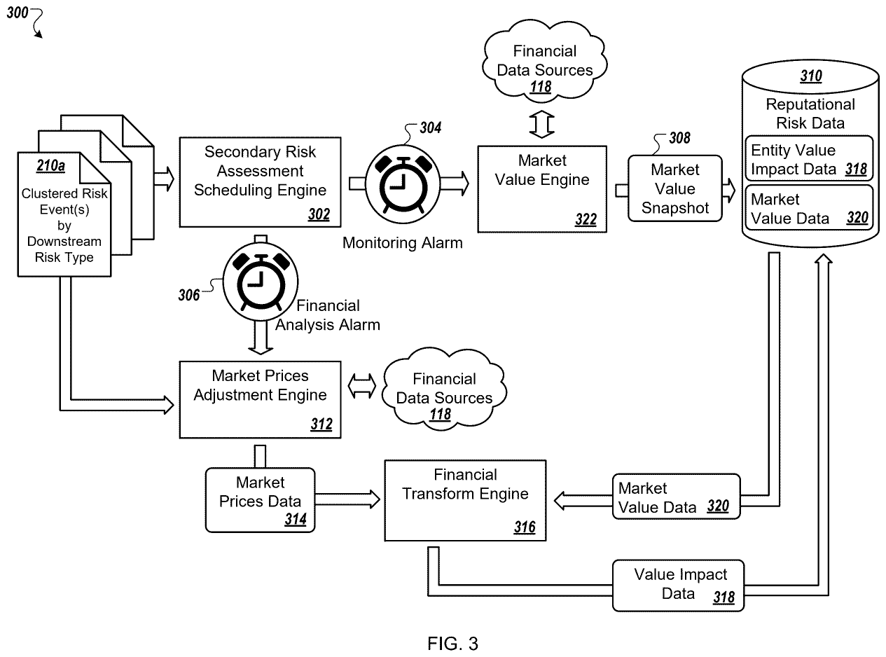

Turning to FIG. 3, a flow diagram illustrates an example process 300 for quantifying the impact of secondary risk stemming from an emerging risk event. As described in relation to FIG. 1B, upon identifying the emerging risk event, an initial snapshot of financial data 117 may be captured. Conversely, in some embodiments, the initial snapshot of financial data 117 may be captured after clustering risk events and refining understanding of the entity involved via the entity refining engine 214 of FIG. 2. To assess whether the emerging risk results in a reputational risk impact, differences in financial data from a time corresponding to the identification of the emerging risk event to one or more later time periods may be analyzed to evaluate whether financial loss has occurred beyond that which may be attributed to the primary emerging risk event. Further, the shift in financial data may be analyzed in view of more general market shifts to isolate change not attributed to other external forces. The process 300 may be performed using the clustered emerging risk events 210 of FIG. 2. The various engines of the process 300, in some embodiments, are configured as software routines or processes (e.g., at least a portion of a software program) coded as instructions for executing on processing circuitry, such as one or more processors. Certain engines or operations performed by certain engines, in some embodiments, are configured as hardware logic (e.g., hardware-based operations) hard-coded or programmed into processing circuitry, such as, in some examples, a programmable logic chip or other programmable logic device, an application-specific integrated circuit (ASIC), or a customized processor device.

In some implementations, the process 300 begins with a secondary risk assessment scheduling engine 302 scheduling one or more monitoring alarms 304 for monitoring a financial status of each organization identified in a set of clustered risk events by downstream risk type 210a (e.g., a subset of the clustered risk events 210 relevant to downstream risk impact). The monitoring alarms 304, in some examples, may be more frequent (e.g., to gather a data corpus encompassing many emerging risk events that may be analyzed to identify trends in timing of reputational risk impact in comparison to the timing of the emerging risk event) or less frequent (e.g., to limit storage and processing resources). Further, in some embodiments, different monitoring alarms 304 may be set on a different schedule, such that certain types of data are gathered less frequently than others (e.g., stock price monitoring may be more frequent than balance sheet monitoring, since balance sheets do not undergo such frequent change). In other embodiments, rather than setting a monitoring alarm, financial data may be automatically captured at the time of entering the process 300.

In some implementations, the secondary risk assessment scheduling engine 302 schedules at least one financial analysis alarm 306 for analyzing financial data collected in relation to one or more organizations identified in the clustered risk events 210a (e.g., based on the monitoring alarm(s) 304) in view of initial financial data (e.g., the entity financial snapshot 117 of FIG. 1B and/or initial financial data captured by the process 300). The financial analysis alarm 306, in some embodiments, is coordinated with a final monitoring alarm of the monitoring alarm(s) 304. For example, rather than having two separate alarms, including a final monitoring alarm 304 and the financial analysis alarm 306, the financial analysis alarm 306 may trigger the same process as the monitoring alarm 304.

In some implementations, a market value engine 116 analyzes current financial data from the financial data sources 118 to determine a market value (e.g., market capitalization or “market cap,” valuation provided in annual reports, etc.) for each organization identified in the clustered risk events 210a. The market value engine 322, for example, may be triggered responsive to the monitoring alarm 304 and/or responsive to creation of the clustered risk event(s) 210a. The market value engine 322 may produce a market value snapshot 308 (e.g., current number of shares and price per share, current market capitalization, etc.). The market value snapshot 308 may be added to a market value data set 320 as part of a reputational risk data collection 310.

Turning to FIG. 5, in some implementations, a financial snapshot data structure includes an entity identification 516a (e.g., one of the entities 516 captured in the event data 502), one or more index prices 542, one or more stock prices 544, a quantity of shares 548, and a capture date 546 corresponding to each collected price 542, 544.

Returning to FIG. 3, in some implementations, a market prices adjustment engine 312 analyzes market financial trends of at least one market relevant to each subject organization (e.g., based on industry, sector, index, stock ticker, and/or other organization obtained from the clustered risk event(s) 210a) to obtain a baseline movement in the applicable market over the span of time that the emerging risk event 210a has been monitored (e.g., beginning with an initial market value snapshot 308 to the day of the financial analysis alarm 306). The market prices adjustment engine 312 may obtain financial data from the financial data sources 118 (e.g., on a periodic basis to collect and retain trend information relevant to various categories of entities that may be subject to emerging risk events, historic data captured by one or more of the financial data sources 118 covering the relevant time period, etc.). The market prices adjustment engine 312, for example, may determine one or more financial trends exhibited within one or more markets. In some examples, the stock market indices for the relevant world region (e.g., North America, Europe, Asia-Pacific, etc.), market changes within a more specific geographic region, market changes within a relevant industry, and/or market changes within a relevant sector may be analyzed by the market prices adjustment engine 312 to identify general financial trends underlying a timeframe between the start of the emerging risk event and the last entity financial snapshot 308. The market prices adjustment engine 312 may generate market prices data 314 representing movements in one or more relevant markets of the relevant time period.

In some implementations, a financial transform engine adjusts the market value data 320 of the subject organization to account for market movements evidenced in the market prices data 314 to produce value impact data 318 representing the financial impact to the entity that may be attributed to a secondary reputational risk event. The value impact data 318 may be stored as entity value impact data 318 in the reputation risk data collection 310.

Although described as occurring once, the financial analysis path of the market prices adjustment engine 312 and the financial transform engine 316 may be repeated. For example, the impact may expand as additional details are discovered regarding the emerging risk event (e.g., the number of systems breached in a cybersecurity attack, the number of user accounts that were exposed to potential data theft, etc.), such that a first review may identify an initial impact, while a subsequent review may identify a deepening impact. Between executions of the financial analysis path, additional market value snapshots 308 may be captured on a same, accelerated, or reduced schedule. The frequency of capture, for example, may be based on a number of factors, such as type of risk event, frequency of movement in the marketplace in general, and/or customization (e.g., based on user request for monitoring).

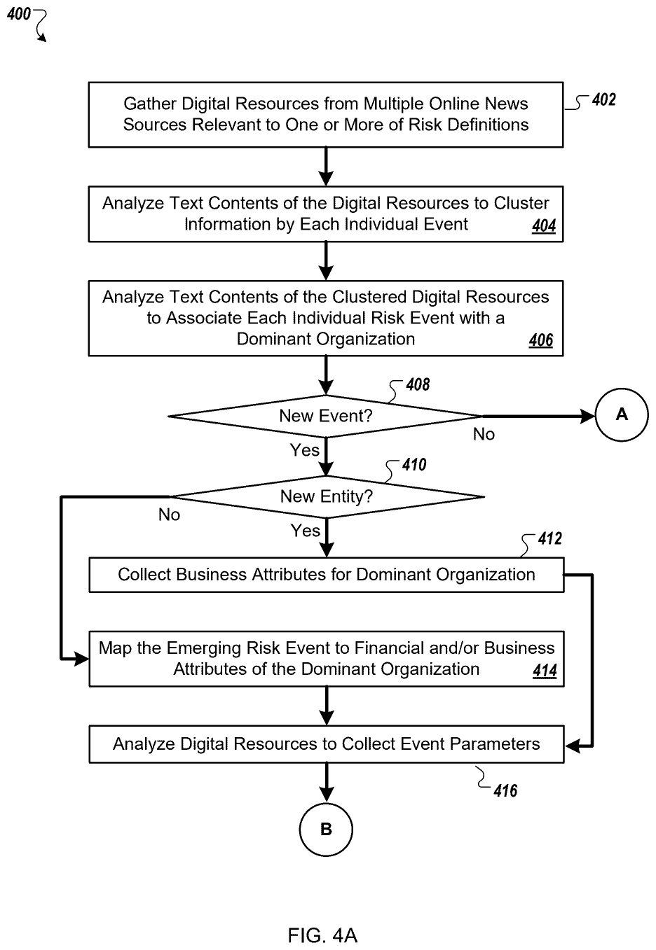

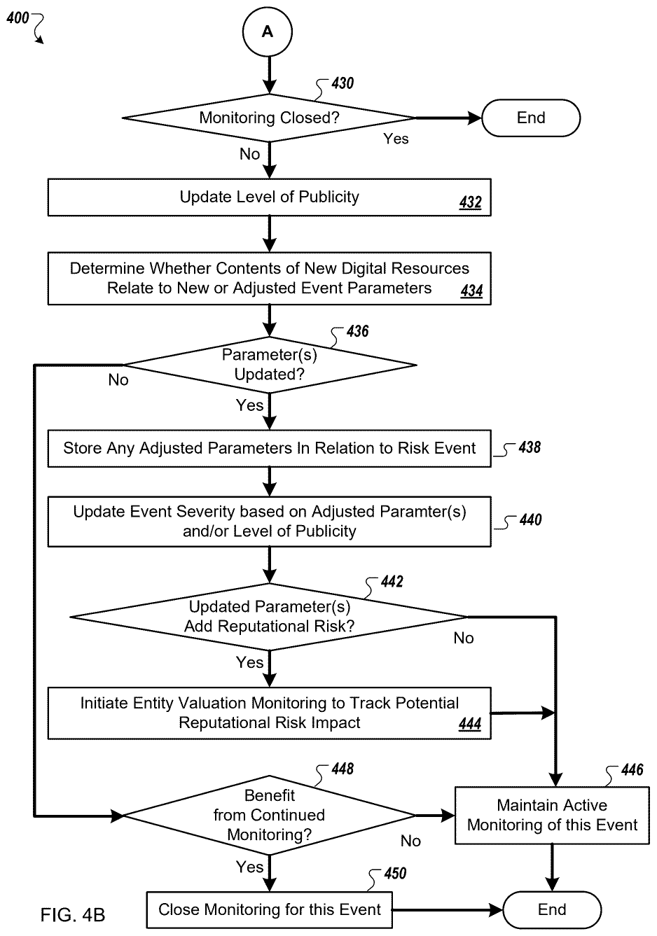

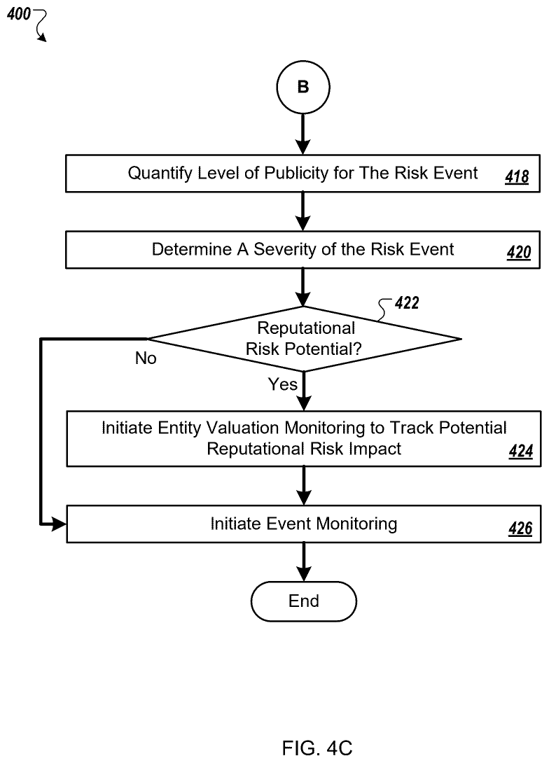

FIG. 4A through FIG. 4C illustrate a flow chart of an example method 400 for identifying and collecting information related to emerging risk events. Aspects of the method 400, may be performed, for example, by certain engines of the process 100 of FIG. 1, the process 200 of FIG. 2, and/or the process 300 of FIG. 3.

Turning to FIG. 4A, in some implementations, the method 400 begins with gathering digital resources from multiple online news sources relevant to one or more risk definitions (402). The information may be gathered, for example, as described in relation to the publication analyzing engine 104 using the risk event definitions 102 of FIG. 1.

In some implementations, text contents of the digital resources are analyzed to cluster the information by each individual event (404). For example, the event validation engine 110 of FIG. 1 may cluster the digital resources into sets based upon discrete risk events 112.

In some implementations, text contents of the clustered digital resources are analyzed to associate each individual risk event with a dominant organization (406). For example, the event validation engine 110 of FIG. 1 may identify the dominant organization in the event entity data 114.

In some implementations, it is determined whether the clustered resources associated with a given risk event correspond to a newly identified risk event (408). As events unfold, additional details may be released via online sources (e.g., the content sources 106 of FIG. 1). Risk event data (e.g., the event data 502 of FIG. 5) may be compared to information derived from the newly clustered resources to determine whether the digital resources correspond to a previously identified emerging risk event.

In some implementations, if the clustered resources correspond to a newly identified risk event (408), it is determined whether the dominant organization is a new entity (410). Entity data, such as the entity data 530 of FIG. 5, may already exist based upon a previously identified emerging risk event. The entity information may be compared to the entity data 530 to identify a preexisting entity.

In some implementations, if the dominant organization of the given emerging risk event is unknown (410), business attributes for the dominant organization are collected (412). The business attributes may be collected, for example, by the entity refining engine 214 of FIG. 2.

If, instead, the dominant organization is known, the emerging risk event may be mapped to financial and/or business attributes of the dominant organization (414). For example, as illustrated in FIG. 5, the event data 502 of the emerging risk event may be mapped to the industry 512 and/or the sector 514 of the entity data 530 for the dominant organization.

In some implementations, the digital resources clustered for the emerging risk event are analyzed to collect event parameters (416). The event parameters, in some examples, may include a location of the emerging risk event, a date or start date of the emerging risk event, an event category, an event type, an event exposure quantification, and/or an event impact quantification. For example, a portion of the event parameters may be stored in the event data structure 502 of FIG. 5. The event distilling engine 210 of FIG. 2 may collect the event parameters.

Turning to FIG. 4C, in some implementations, a level of publicity for the emerging risk event is quantified (418). The publicity level, for example, may equate to a level of press associated with the risk event (e.g., a number of digital resources, a geographic reporting distribution of the digital resources, etc.). The publicity level may further be based on a typical level, or a set of publicity tiers, determined from past emerging risk events of the same type. The publicity level may further be adjusted, in some embodiments, based on a reputation of the organization (e.g., whether the organization or its product(s) is a household name) and/or other factors regarding the risk event, such as the geographic region, industry, and/or sector. For example, greater media emphasis may be placed on events occurring in major financial markets (e.g., North America, Europe, China, etc.), and/or within sectors or industries of great interest to the general public.

In some implementations, a severity level of the risk event is determined (420). In some circumstances, the severity level may be derived from the digital resources, such as a hurricane's severity level. In other circumstances, the severity level may be determined based in part on the publicity level. The severity, further, may relate to the exposure quantification and/or the impact quantification (described, for example, in relation to FIG. 5).

In some implementations, it is determined whether the emerging risk event creates the potential for a reputational risk event (422). The event classifying engine 126 of FIG. 1, for example, may determine one or more types of potential secondary risk, including reputational risk.

If the risk event creates the potential for a reputational risk event (418), in some implementations, entity valuation monitoring is initiated to track potential reputational risk impact (424). The entity valuation monitoring, for example, may be performed as described in relation to the process 300 of FIG. 3.

In some implementations, event monitoring is initiated (426). After initial identification of the emerging risk event, further details and additional information may be released through online content sources over the course of additional days or even weeks. With event monitoring, in some embodiments, later digital resource postings may be analyzed and their contents added to contribute to information such as the exposure quantification and/or the impact quantification. As described in relation to operation 408, for example, the event may not be new (e.g., it may be in a monitoring stage for further information).

Returning to FIG. 4A, in some implementations where the given risk event is not a new event (408), as illustrated in FIG. 4B, it is determined whether monitoring is closed for the risk event (430). As noted in FIG. 4C, event monitoring may be initiated (426) to continue to track coverage of an emerging risk event. If monitoring remains ongoing (430), in some implementations, a level of publicity associated with the emerging risk event is updated (432). The level of publicity, for example, may be calculated in the manner described in relation to operation 418 of FIG. 4C.

In some implementations, it is determined whether the contents of the new digital resources relate to new or adjusted event parameters (434). For example, the new digital resources may be analyzed as described in relation to operation 416 of FIG. 4A, and compared to the originally stored event parameters.

If the new digital resources include updated parameters (436), in some implementations, any adjusted parameters are stored in relation to the emerging risk event (438). The parameters may be stored, for example, in the event data 502 and/or other event data linked to the event data 502 (e.g., the cybersecurity event data 520), as described in relation to FIG. 5.

In some implementations, the event severity is updated based on one or more of the adjusted parameters and/or the level of publicity (440). The event severity, for example, may be determined in the manner described in relation to operation 420 of FIG. 4C.

In some implementations, if the updated parameter(s) add a new aspect of reputational risk (442), entity valuation monitoring is initiated to track potential reputational risk impact (444). For example, the original, limited details regarding the emerging risk event may not have captured details relevant to the potential for a secondary reputational risk-related loss occurring. In this circumstance, as details unfold that point to the potential for reputational risk, valuation monitoring may be initiated as described in relation to operation 424 of FIG. 4C.

When one or more parameters have been updated, in some implementations, active monitoring of the event is maintained (446). For example, since new details are still being released to the public, the emerging risk event can be considered to remain active.

In some implementations where no parameters have been updated (436), it is determined whether there may be a benefit derived through continued monitoring (448). As publicity wanes and no new information is automatically gleaned through analysis of new digital resources, the emerging risk event may be deemed as not requiring additional monitoring. In this manner, if a similar event strikes the same organization a second time (e.g., a series of wildfires, etc.), the second event will be recognized as a separate emerging risk event. In addition to and/or instead of waning publicity, the monitoring may be closed upon the end of secondary risk monitoring. In some embodiments, where it is determined that continued monitoring is not beneficial (448), monitoring for the emerging risk event is closed (450). Upon closing, for example, the event data may be archived and made available for historic trend analysis. In some embodiments, upon determining that additional benefit may be derived through continued monitoring (448), active monitoring is maintained for the emerging risk event (446).

Although described as a particular set of operations, in other embodiments, the method 400 may include more or fewer operations. For example, in certain embodiments, no reputational risk analysis may be performed. Although described as a series of operations, in other embodiments, certain operations may be performed in a different order and/or a portion of the operations of the method 400 may be performed at least partially concurrently. For example, the digital resources may be analyzed to collect event parameters (416 before and/or concurrent with analyzing the text contents to associate the risk event with a dominant organization (406). Other modifications to the method 400 may be made.

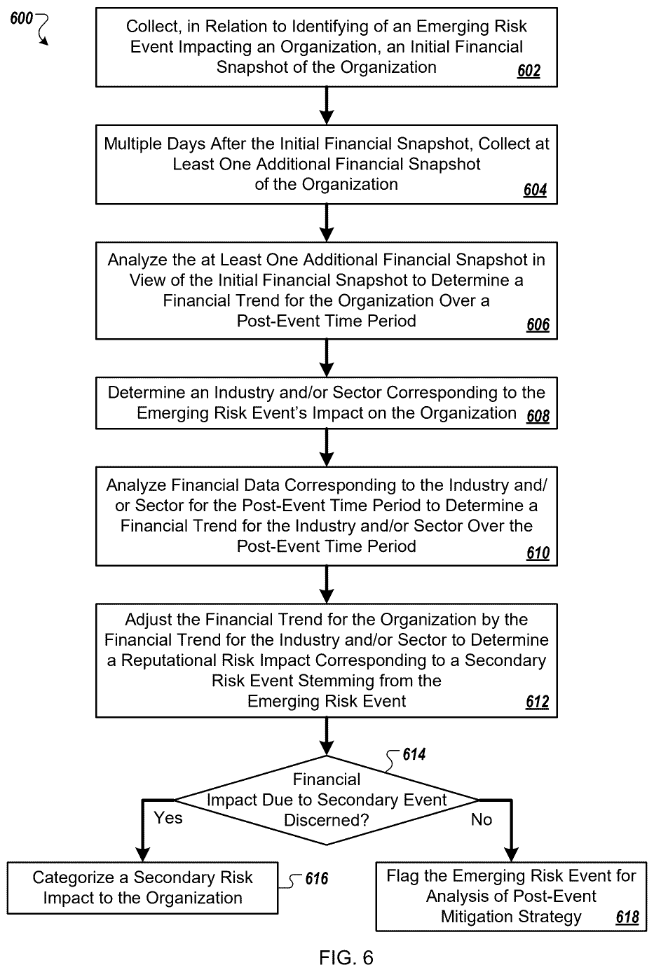

Turning to FIG. 6, a flow chart presents an example method 600 for performing historic trend analyses on reputational risk event data. Portions of the method 600, for example, may be performed by various engines of the process 300 of FIG. 3.

In some implementations, the method 600 begins with collecting, in relation to identifying an emerging risk event impacting an organization, an initial financial snapshot of the organization (602). The initial financial snapshot, for example, may be the market value snapshot 308 collected by the market value engine 322 of FIG. 3.

In some implementations, at least one additional financial snapshot of the organization is collected multiple days after the initial financial snapshot was gathered (604). The number of days, in some examples, may include at least 14 days, up to 30 days, from 30 days to 90 days, from 90 days to about four months, from about four months to about six months, from about six months to about nine months, or from about six months to about a year. The financial ramifications of a reputational impact may demonstrate significant lag. In some illustrative examples, market response to an emerging risk event may be delayed due to the delay in shareholder information distribution, the delay in running out of present stock (e.g., in a supply chain issue), and/or the delay in response implementation. Regarding response implementation, a minor financial impact (e.g., shareholder loss of confidence) may be corrected through a course of action taken by the organization. Thus, to evaluate for significant and longstanding financial impact, the reputational risk financial impact evaluation may be performed after a number of months have passed. The specific length of time may be based, for example, on historic analysis of financial impact due to reputational risk. The market value engine 322 of FIG. 3, for example, may collect the at least one additional financial snapshot.

In some implementations, the at least one additional financial snapshot is analyzed in view of the initial financial snapshot to determine a financial trend for the organization over a post emerging risk event time period (606). For example, the market value data 320 may be analyzed by the financial transform engine 316 of FIG. 3 to determine the financial trend of the market value of the subject organization.

In some implementations, an industry and/or sector corresponding to the emerging risk event's impact on the subject organization is determined (608). The industry and/or sector, for example, may be determined from data stored to the event entity data 122 (e.g., by the entity refining engine 214 of FIG. 2 and/or the organization registration/validation engine 110 of FIG. 1B).

In some implementations, financial data corresponding to the industry and/or sector is analyzed for the post-event time period to determine a financial trend for the industry and/or sector over the post-event time period (610). The financial data, for example, may include stock index values from the beginning date of the emerging risk event (or capture of first financial data for the subject organization) to a current date. Rather than using a commercial index, in some embodiments, a collection of data corresponding to key competitors in the industry and/or sector may be combined to obtain the financial data corresponding to the industry and/or sector. The market prices adjustment engine 312 of FIG. 3, for example, may analyze the financial data corresponding to the industry and/or sector.

In some implementations, the financial trend for the organization is adjusted by the financial trend for the industry and/or sector to determine a reputational risk impact corresponding to a secondary risk event stemming from the emerging risk event (612). For example, it may be assumed that the subject organization's financial trajectory would generally follow the trend for its market and/or sector. Thus, if, during the relevant time period the industry and/or sector as a whole was impacted by a separate market force outside of the emerging risk event, the separate market force may be nullified by quantifying it and removing it from the financial trend of the organization itself during the relevant time period. The financial transform engine 316 of FIG. 3, for example, may adjust the market value trend of the organization evidenced in the market value data 320 in view of the financial trend of the market prices data 314 as calculated by the market prices adjustment engine 312 to identify the value impact data 318 representing any shift in value of the organization that cannot be attributed to general market trends. The value impact data 318, thus, may be assumed to be related to the reputational risk.

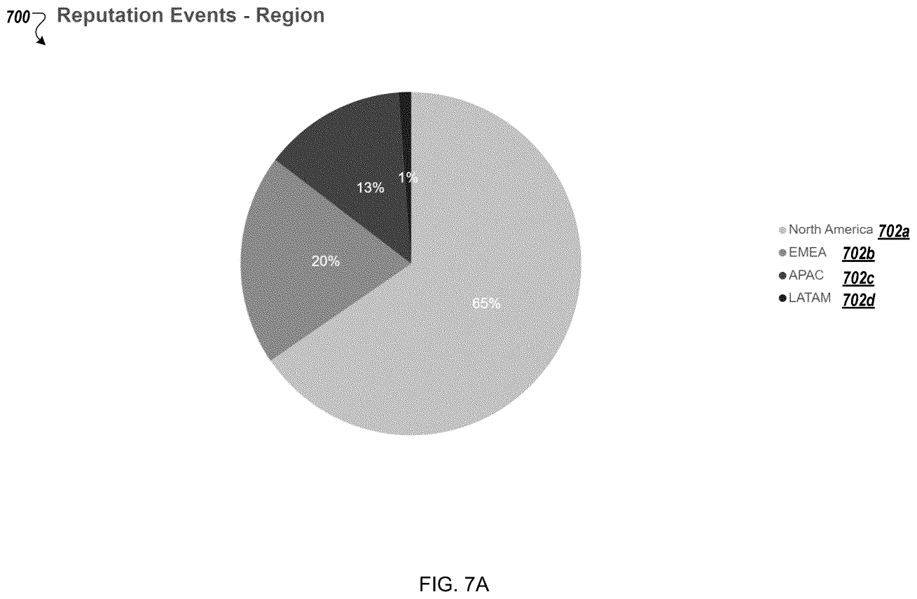

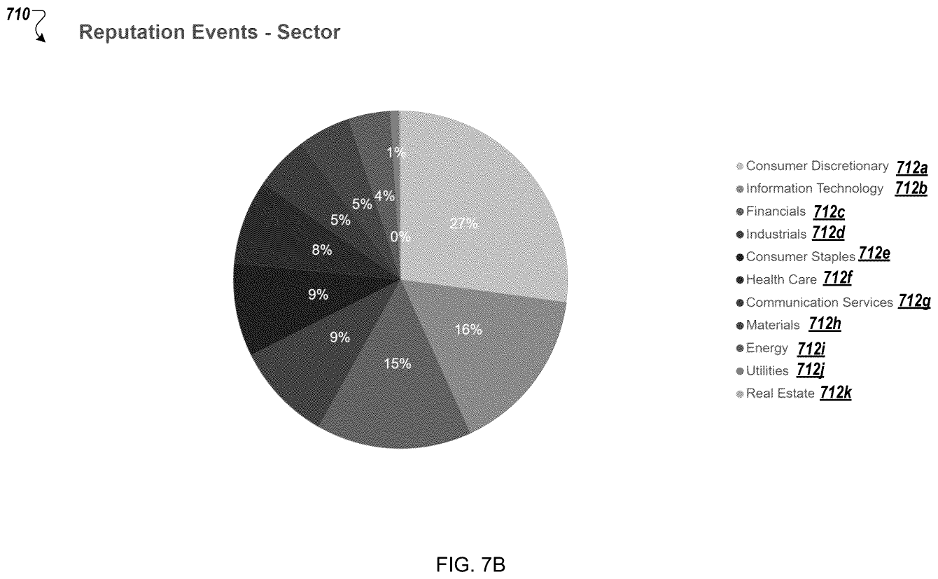

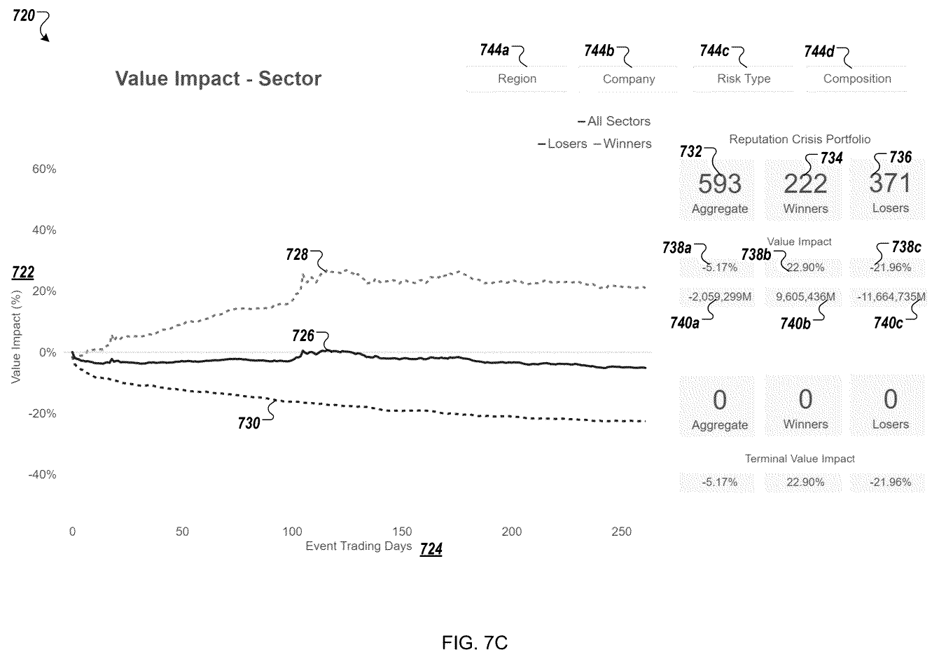

Turning to FIG. 7C, an example graphical user interface 720 illustrates a percentage value impact 722 to organizations over the course of a little over 250 days 724. The value impact data 318 of aggregate organizations 732 (e.g., 593), for example, may have been evaluated to produce the example graphical user interface 720, in which the organizations have been divided into a set of winners 734 (e.g., 222) and a set of losers 736 (e.g., 371). As illustrated in the graph of value impact 722 over event days 724, an “all sectors” plot 726 tracks a relative change in value (e.g., from day 0 at 0%) of the aggregate organizations 732 as a whole. A winners plot 728 tracks a relative change in value of the winners 734 (e.g., those organizations that increased in value from day 0 to the end of the event trading days 724), and a losers plot 730 tracks a relative change in value of the losers 736 over the event trading days 724. A value impact at the end of the trading days 724 demonstrates that the aggregate organizations lost 5.17% value 738a, the winners increased in value by 22.9% 738b, and the losers decreased in value by 21.96% 738c. The change in value has also been captured in millions of dollars 740a-c.

To refine the analysis presented in the example graphical user interface 720, a user may filter the data presented by region 744a, by company (e.g., organization) 744b, by risk type 744c (e.g., primary emerging risk type), and/or by composition 744d. In composition mode, for example, the composite components may be broken out by category (e.g., by region, by sector, by industry, etc.). For example, the example graph 700 of FIG. 7A and the example graph 710 of FIG. 7B illustrate composition breakdowns by region and by sector, respectively.

Returning to FIG. 6, in some implementations, if a secondary financial impact is discerned (614), a secondary risk impact to the organization is categorized (616). In some circumstances, it may be determined that, based on the calculations in view of the industry and/or sector, the organization's financial trajectory has been on par with its peers. In determining whether there has been a discernable secondary financial impact, in some embodiments, the method 600 calculates whether an anticipated financial value of the organization differs from an actual financial value of the organization by at least a threshold amount and/or a threshold percentage. The threshold value(s), in some embodiments, are based at least in part on a distribution of outcomes among peer organizations within the industry and/or sector.

In some implementations where there has been a discernable financial impact attributable to a secondary risk event (e.g., reputational and/or supply chain), a secondary risk impact to the organization is categorized (616). In the simplest form, a secondary risk event may be logged in relation to this organization (e.g., a binary yes, the organization was impacted by a secondary risk event). For example, as illustrated in an example graphical user interface 700 of FIG. 7A, a pie chart of reputational events by region (e.g., by calendar year, by quarter, etc.) is illustrated. In this circumstance, the geographic region of the event (e.g., the geographic region of the organization or the geographic region of the emerging risk event) is analyzed to quantify a share of reputational risk events per each of North America 702a (e.g., 65%), Europe, Middle East, and Africa (EMEA) 702b (e.g., 20%), Asia-Pacific (APAC) 702c (e.g., 13%), and Latin America (LATAM) 702d (e.g., 1%). In another example, turning to FIG. 7B, an example graphical user interface 710 illustrates a pie chart of reputational events by sector. In this circumstance, the sector of the organization impacted by the emerging risk event is analyzed to quantify a share of reputational risk events per each of consumer discretionary 712a (e.g., 27%), information technology 712b (e.g., 16%), financials 712c (e.g., 15%), industrials 712d (e.g., 9%), consumer staples 712e (e.g., 9%), health care 712f (e.g., 8%), communication services 712g (e.g., 5%), materials 712h (e.g., 5%), energy 712i (e.g., 4%), utilities 712j (e.g., 1%), and real estate 712k (e.g., 0%). In other embodiments, a relative severity of the secondary risk event may be quantified. For example, based on a relative difference between the anticipated financial trajectory of the organization and the actual financial trajectory of the organization, the secondary risk event may be quantified as minor, serious, or severe. Perhaps, if the organization has a major financial event such as bankruptcy, the secondary risk event may be quantified as catastrophic. Other categorizations are possible.

In the example of a supply chain risk, in some embodiments, diagnostic metrics may compare supply chain risk mitigation effectiveness against multiple critical supplier and/or enterprise exposures.

In some implementations, where a financial impact attributable to a secondary risk event is not discerned (614), the emerging risk event is flagged for analysis of the post-event mitigation strategy adopted by the organization. For example, the post-event mitigation strategy may be analyzed by other organizations impacted by a similar primary emerging risk event to develop a mitigation plan with at least some proven track record for being successful in staving off the further impact of a reputational risk event.

Although described in relation to the industry and/or sector (608), in other embodiments, the stock index, relevant stock ticker, geographical region of the corporate headquarters, and/or the geographic region of the emerging risk event may be determined and used to calculate financial trends in an appropriate comparison market. In other embodiments, certain operations of the method 600 may be performed in a different order and/or concurrently. For example, the financial data corresponding to the industry and/or sector may be analyzed (610) prior to or concurrently with analyzing the additional snapshot(s) in view of the initial financial snapshot (606). In further embodiments, the method 600 may include more or fewer operations. Other modifications of the method 600 are possible.

FIG. 8A and FIG. 8B illustrate example graphical user interfaces presenting regional analyses of emerging risk events by event type. The graphical user interfaces, for example, may be developed using the data and metrics generated through the process 100 of FIG. 1A, the process 120 of FIG. 1B, the process 200 of FIG. 2, and/or the method 400 of FIG. 4A through FIG. 4C.

Turning to FIG. 8A, an example graphical user interface (GUI) 800 illustrates a risk overview based on types of emerging risk and frequency of each within various geographic regions (e.g., countries). The data, for example, may represent a period of time such as a business year, a calendar year, or a business quarter. The GUI 800 may be reviewed by an entity to determine preferred regions of operation and/or to distribute risk better across a supply chain based on frequency of different types of risk in each region. For example, when deciding where to place a new data center, the propensity for cyber attacks may be reviewed in the various countries.

As illustrated, the GUI 800 includes a graph of top risks by country, each country overlaid with a color-coded risk bubble. Further, the risk bubbles may be sized to represent overall propensity within the region as compared to other countries (e.g., the bubble over the United States is larger than the bubble over Canada). The color-coded risks, for example, may include cyber attacks, disaster at location, insolvency, labor practices, product delays, and/or product recall (e.g., as broken out in a graphical user interface 820 of FIG. 8B).

A donut graph of events split by risk 804 breaks down the various risk categories 806 by the portion of total emerging risks detected (e.g., cyber attacks, disaster at location, insolvency, labor practices, product delays, and product recall).

A top events by frequency listing 808 may list the top events of the subject time period by frequency of mention in the press (e.g., number of articles detected by the process 100 of FIG. 1A later determined by the event data clustering engine 202 to belong to a single event). Each event 186a-e of the top events by frequency 808 is listed along with its corresponding risk category 810, a brief summary of the event (e.g., the representative title discussed in relation to the event data clustering engine 202), and the corresponding sector 814.

In other embodiments, an event trend graph (not illustrated) may be presented to illustrate a number of events (e.g., cyber attack events, etc.) per time period (e.g., month, quarter, etc.) over a span of time (e.g., six months, one or more years, etc.). The event trend graph, in some examples, may demonstrate whether a type of event is becoming more or less frequent and/or certain quarters that are more active for the time of event.

In further embodiments, an event by company graphic may illustrate a number of companies effected by each of a category of number of event instances (e.g., none, only one, two, up to three, three or more, etc.) within a topic timeframe (e.g., one year, two years, up to five years, etc.). The event by company graphic, for example, may demonstrate that a majority of companies suffered only a single cyber attack incident within the subject timeframe, while approximately a same number or percentage of companies suffered two cyber attack events within the topic timeframe as suffered three or more cyber attacks within the topic timeframe.

Turning to FIG. 8B, an entity region analysis graphical user interface 820 presents a breakdown of risk by geographic region 822 (e.g., APAC 822a, EMEA 822b, LATAM 822c, and North America 822d). The information is broken out further by type of event 824. An organization may review the GUI 820, for example, when determining solutions for supply chain providers.

In an events breakdown by region bar graph section 826, a user can quickly identify which region is most frequently visited by each different type of attack. For example, APAC 822a has the largest percentage of disasters at location 824b and labor practice problems 824d, while North America has the greatest percentage of insolvencies 824c and product recalls 824f.

A risk frequency by region donut graph 828 illustrates overall frequency of emerging risk events, as a percentage of total risk events, for each of the regions 822. As illustrated, emerging risk events are generally most common in North America 822d and least common in LATAM 822c.

A top risk by region listing 830 lists the most common risk 832 for each region 822. As illustrated, although product recalls 824f are most common in North America 822d, APAC's top risk is product recall. Further, although North America 822d has more insolvencies 824c than any other region, North America's most common risk is product recall.

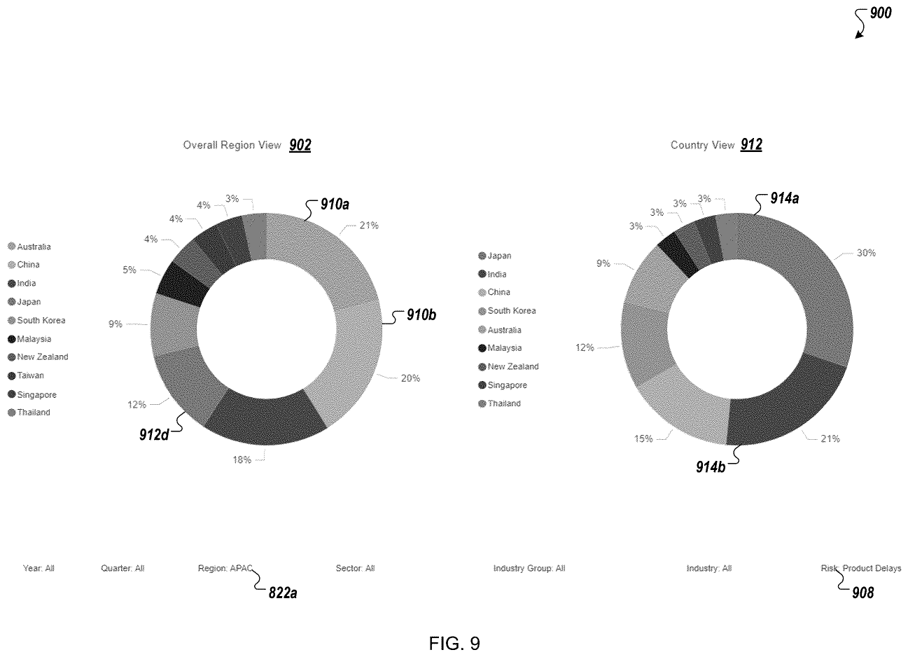

FIG. 9 illustrates an example graphical user interface 900 presenting regional analysis of risk events. The GUI 900, for example, may demonstrate how risks impact various countries and various regions.

In a region donut graph 902, the APAC region 822a is broken down by representative country, with each country represented as percentage of total impact of all types of risk. As illustrated, the country that experienced the greatest emerging event risk in APAC 822a was Australia 910a, followed by China 910b

Turning to a country view donut graph 912, the countries of the APAC region 822a are represented in relation to a selected risk, in this circumstance product delays 908. As illustrated, Japan 914a experienced the greatest impact of product delay risk, followed by India 914b.

In reviewing the GUI 900, a representative of an organization is presented differentiators between the “riskiest” countries in the APAC region 822a versus the countries experiencing the highest level of risk in an area that is of particular interest to the organization. For example, while Japan 912d is ranked fourth in overall risk at only 12% of the emerging risk impact across the APAC region 822a, it experiences nearly a third of the entire APAC product delay risk impact.

Reviewing large sets of publications regarding emerging risk events can be resource intensive, expensive, and time consuming. Rather than reviewing all documentation collected regarding an emerging risk event, in some implementations, the documentation can be classified using intelligent screening. The screening, for example, provides a technical solution to the problem of proliferation of redundant literature, such as news articles covering the same story and including generally the same facts and descriptions. The screening resolves the issue by reducing the quantity of documents to a small number of example publications containing both a rich set of data and a diverse coverage regarding the emerging risk event. For example, the screening may identify articles that provide the most information gain along with a broad range of article style/composition.

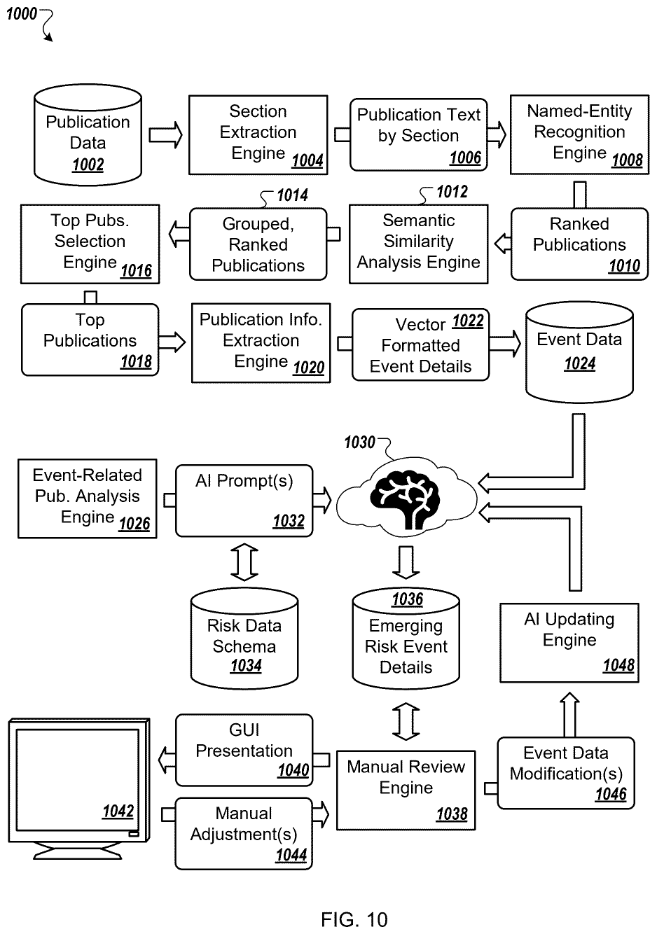

Turning to FIG. 10, a flow diagram of an example process 1000 illustrates a solution to reducing tens, hundreds, or even thousands of publications regarding an emerging risk event to a handful (e.g., up to ten, up to a dozen, up to two dozen, etc.) of articles each demonstrating high value in both richness of information and diversity in content. Portions of the process 1000, for example, may be performed by and/or replace certain operations of the publication extraction engine 103 and/or the publication analyzing engine 104 of the process 100 of FIG. 1A. Portions of the process 1000, for example, may replace operations performed by the event data clustering engine 202 of FIG. 2, thereby replacing potentially expensive artificial intelligence analysis with less computationally intensive language processing analysis. In illustration, an event cluster developed by the event data clustering engine 202 of FIG. 2 may include, even after initial processing, filtering, and organizing as described in relation to FIG. 1A, hundreds, a thousand, or even two thousand or more individual publications, depending upon the magnitude of the emerging risk event and/or the newsworthiness of the organization. The process 1000 may be designed to streamline expensive artificial intelligence processing (e.g., performed by the cluster analysis engine 205 of FIG. 2) while avoiding loss of valuable information by intelligently screening the large number of individual publications within the cluster. Further, the process 1000 may be configured to retain a sufficient collection of individual publications to enable validation of emerging risk event facts when inconsistent information is discovered through the detailed artificial intelligence analysis. In this manner, the process 1000 provides a technical solution to the technical problem of the computing resource intensity of applying artificial intelligence processing to unstructured natural language data for the purpose of deriving a factual summary of details of an event. The various engines of the process 1000, in some embodiments, are configured as software routines or processes (e.g., at least a portion of a software program) coded as instructions for executing on processing circuitry, such as one or more processors. Certain engines or operations performed by certain engines, in some embodiments, are configured as hardware logic (e.g., hardware-based operations) hard-coded or programmed into processing circuitry, such as, in some examples, a programmable logic chip or other programmable logic device, an application-specific integrated circuit (ASIC), or a customized processor device.

In some implementations, the process 1000 begins with a section extraction engine 1004 extracting one or more article sections from a set of publication data 1002. The publication data 1002, for example, may be a portion of the source news articles 101 and/or the emerging risk article data 105 of FIG. 1A. The sections, for example, may include an article title and an article body. The sections may be extracted, for example, based on section identifiers within the publication data 1002 and/or using natural language processing (NLP) to parse sections of each publication (e.g., title, abstract, body, signature, etc.). The section extraction engine 1004, for example, may provide a set of publication sections 1006 (e.g., publication bodies) to a named-entity recognition engine 1008.

In some implementations, the named-entity recognition engine 1008 applies named-entity recognition to the set of publication sections 1006 to identify dominant values for each of a defined set of entity types. The named-entity recognition engine 1008, for example, may perform natural language processing on the set of publication sections 1006 to categorize words and phrases within the set of publication sections 1006 based on entity types to recognize key information within each of the set of publication sections 1006. The entity types, in a first example, can include organization information (e.g., organization name, headquarter location, office location, product name(s), product identifier(s), service name(s), service identifier(s), and/or names of high-ranking (e.g., c-suite) officials within the organization, etc.). The named-entity recognition engine 1008, for example, may be trained or fine-tuned to recognize corporate named-entities corresponding to major corporations and/or business leaders. In a second example, the entity types can include emerging risk event information (e.g., the “who,” “what,” “when,” “why,” “where,” and “how,” such as the location of event, the timing of event, who the event effects, what occurred in the event, how the event took place, etc.). The named-entity recognition engine 1008, for example, may be trained or fine-tuned to parse the “5W1H” facts out of news articles based on contextual cues within the text. The where, for example, can include areas defined by political boundaries, a governing body applicable to a geographic area, and/or another representation of geographic region.

In some embodiments, the named-entity recognition engine 1008 qualifies the use of named entities within each publication section 1006. The named-entity recognition engine 1008 may determine, for each publication section 1006, a count of unique named-entity types for which values were determined. In another example, the named-entity recognition engine 1008 may determine a count of instances for each unique named-entity value or named-entity type (e.g., how many times company A was mentioned, how many times location B was mentioned, etc.). The named-entity recognition engine 1008, in another example, may identify a prominence of mentioning of certain named-entities, such as whether the named-entity value occurs early in the text of the publication section 1006.

In some embodiments, the named-entity recognition engine 1008 identifies, based at least in part on the counts, dominant values for each entity type of at least a portion of the entity types across all publications of the set of publication sections 1006. For example, the named-entity recognition engine 1008 may recognize a top N named companies, a top N identified locations, etc. Further, the named-entity recognition engine 1008 may rank the prominence of each named-entity value based on frequencies and/or prominence across the set of publication sections 1006.

The named-entity recognition engine 1008, in some embodiments, ranks the publications of the publication data 1002 based at least in part on the number of named entities present in each article to produce a set of ranked publications 1010. The named-entity recognition engine 1008, for example, may count instances of each type of entity (e.g., organization, product, location, etc.) and/or each unique named entity (e.g., “Boise, Idaho,” “Acme, Corporation,” “Swizzle Widgets,” etc.). The named-entity recognition engine 1008, further, now rank and/or score each publication based in part on contents of other sections, such as title contents. The named-entity recognition engine 1008 may rank the publications, in some examples, based in part on frequency of named entities within body text, highest count(s) of named entities within body text, and/or highest counts of the most dominant named entities found within the set of publication sections 1006 (e.g., the body text sections). In another example, a breadth of types of named entities may be promoted within the rankings, since the underlying publication may include more details to determine the who, what, when, where, why, and how of the emerging risk event. Certain named entities or types of named entities may be weighted more heavily than others in ranking the publications as the ranked publications 1010. For example, instances of the dominant named entities may be weighted in comparison to other named entities included within a given publication. Weighting, in some embodiments, may be based in part on the type of emerging risk (e.g., cyber security risks may be less location intensive than civil war risk). The named-entity recognition engine 1008, in illustration, may calculate a respective score for each publication based on analyzing the named entities within at least the body text.

In some implementations, a semantic similarity analysis engine 1012 analyzes the ranked publications 1010 to group the ranked publications 1010 based on similarity of contents. Oftentimes, news will be replicated across jurisdictions from an original press release, such that set of publications will be identical or near-identical in content. In another example, subsequent article corrections and/or article addendums may result in the release of near-identical content within a short timeframe, such as the same day or a following day. The semantic similarity analysis engine 1012 may analyze grammatical structure and contents of the body text of the ranked publications 1010 to group the ranked publications 1010 based on semantically similar structure, thereby clustering replicated content. The semantic similarity analysis engine 1012 may produce a set of grouped, ranked publications 1014 where duplicate or near-duplicate contents are associated together.

A top publications selection engine 1016, in some implementations, selects, from the grouped, ranked publications 1014, a set of top publications 1018. The top publications selection engine 1018, in a first example, may select one representative article from each cluster of the top N ranked clusters. The representative article, in some examples, may be selected based on rank within the cluster, recency of publication, and/or trustworthiness of the news source. In some embodiments, the top publications selection engine 1018 selects a publication from all publication groups containing at least one publication scored above a certain value (e.g., as calculated by the named-entity recognition engine 1008).

In some implementations, a publication information extraction engine 1020 extracts event details 1022 from each of the top publications 1018. The publication information extraction engine 1020, for example, may perform certain operations of the event data clustering engine 202, such as transforming one or more of the publication text sections 1006 (e.g., title, abstract, body text, etc.) of each publication into at least one vector format usable by an AI network 1024 for processing. The vector formats, for example, may be arranged and/or labeled (e.g., tagged) using the named entities recognized in the body text by the named-entity recognition engine 1008. The vector formats may be stored as vector formatted event details 1022 to an event data vector database 1024.

In some implementations, an event-related publication analysis engine 1026 prompts one or more artificial intelligence networks 1030 using one or more AI prompts 1032 designed to extract details from the event data 1024 defining the risk event. The AI prompt(s) 1032 may instruct the AI network(s) 1030 to organize the event details according to a risk data schema 1034, defining types and relationships between event details. FIG. 5, for example, illustrates an example risk data schema. The AI prompt(s) 1032 may be formulated to extract each data variable of the risk data schema from the event data 1024.

Responsive to the AI prompt(s) 1032, in some implementations, the AI network(s) 1030 analyze the event data and arrange emerging risk event details 1036 according to the risk data schema 1034. The AI network(s) 1030, for example, may collect relevant phrases or data values according to each variable identified in the risk data schema 1034 as may be discovered within the event data 1024. Further, the AI network(s) 1030 may provide a confidence value representing a confidence level in the information collected within the emerging risk event details 1036. The confidence level, for example, may reflect a likelihood that the information stored to the emerging risk event details 1036 contains complete and accurate information responsive to each particular variable identified by the risk data schema 1034. In the event of discovery of two or more conflicting data values discovered by the AI network(s) 1030 during analysis, in one example, redundant AI networks 1030 may be employed to collect information, and a consensus (e.g., ⅘, 7/10, etc.) of the values returned may be captured as the correct values. In another example, values reported in a majority of the publications may be accepted as the correct value, while outlier information is discarded. In identifying outliers, publications, in some embodiments, are separated by trustworthiness, with a weighted confidence value applied to a most trusted tier of publications.

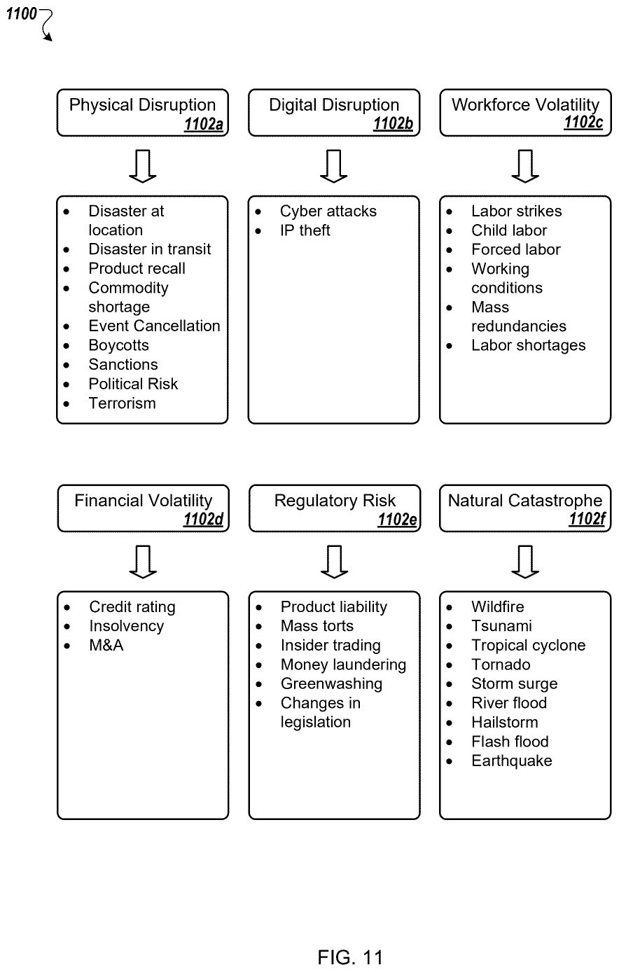

In some embodiments, the risk data schema 1034 is arranged in part to reflect similarities in details between differing types of emerging risks. Turning to FIG. 11, for example, an example data arrangement 1100 illustrates a set of categories 1102 of data points that overlap among types of emerging risk. As illustrated, example categories include physical disruption details 1102a, digital disruption details 1102b, workforce volatility details 1102c, financial volatility details 1102d, regulatory risk details 1102e, and natural catastrophe details 1102f. The risk data schema 1034, for example, may include a layered structure borrowing from variables impacting the set of categories 1102 based on the type of emerging risk. Further, different AI networks 1030 may be fine-tuned to recognize aspects related to each of the set of categories 1102. Additionally, the risk data schema 1024 may include details relevant across all emerging risks, such as the organization details and geographic region. These global variables, for example, may be recognized by one or more AI networks 1030 fine-tuned in discerning the common data types.

Returning to FIG. 10, in some implementations, a manual review engine 1038 generates, for presentation at the screen of a computing device 1042 a reviewer, a graphical user interface (GUI) presentation 1040 of details regarding the population of the risk data schema 1034 by the AI network(s) 1030. The manual review engine 1038, for example, may organize the emerging risk event details 1036 in the GUI presentation 1040 with human-legible labels identifying each piece of information (e.g., type of emerging risk, organization(s) effected, date(s) of event, etc.). Additionally, the GUI presentation 1040 may include a set of controls configured to allow the reviewer to manually adjust one or more data elements. The manual review engine 1038, for example, may provide the GUI presentation 1040 upon request by a reviewer. In another example, the GUI presentation 1040 may include, highlighted for consideration, those values of the emerging risk event details 1036 involving a confidence level below a particular threshold and/or conflicting or inconsistent values as identified by the AI network(s) 1030.

In some implementations, if the reviewer applies one or more manual adjustments 1044 to the emerging risk event details 1036, the manual review engine 1038 updates the emerging risk event details 1036, as stored.

In some embodiments, responsive to receiving manual adjustment(s) 1044 from the reviewer, the manual review engine 1038 provides the event data modifications 1046 to an AI updating engine 1048 for use in updating the fine-tuning of one or more of the AI network(s) 1030.

Although illustrated as particular set of engines, in other embodiments, the process 1000 involves more or fewer engines than illustrated. For example, an intensity of coverage analysis engine may analyze publication data 1002, for example including a count of total publications, a number of clusters identified by the semantic similarity analysis engine 1012, and/or a number of publications within each of the top one to N clusters as identified within the grouped, ranked publications 1014 to identify events that may be relevant to reputational impact. The intensity coverage analysis engine may further flag the event for later review in relation to reputational impact (e.g., by the process 300 of FIG. 3 and/or the method 600 of FIG. 6). In another example, the semantic similarity analysis engine 1012 may filter the ranked publications 1010 to produce the top publications 1018 rather than providing grouped, ranked publications 1014 to the top publications selection engine 1016. Although the process 1000 is illustrated as being organized in a particular order of operations, in other embodiments, the flow of the process 1000 may involve a different order of operations, or certain operations may be performed concurrently. For example, the publications may be first clustered by semantic similarity engine 1012 and then the clusters ranked by the ranked publications engine 1010. Other modifications of the process 1000 are possible.

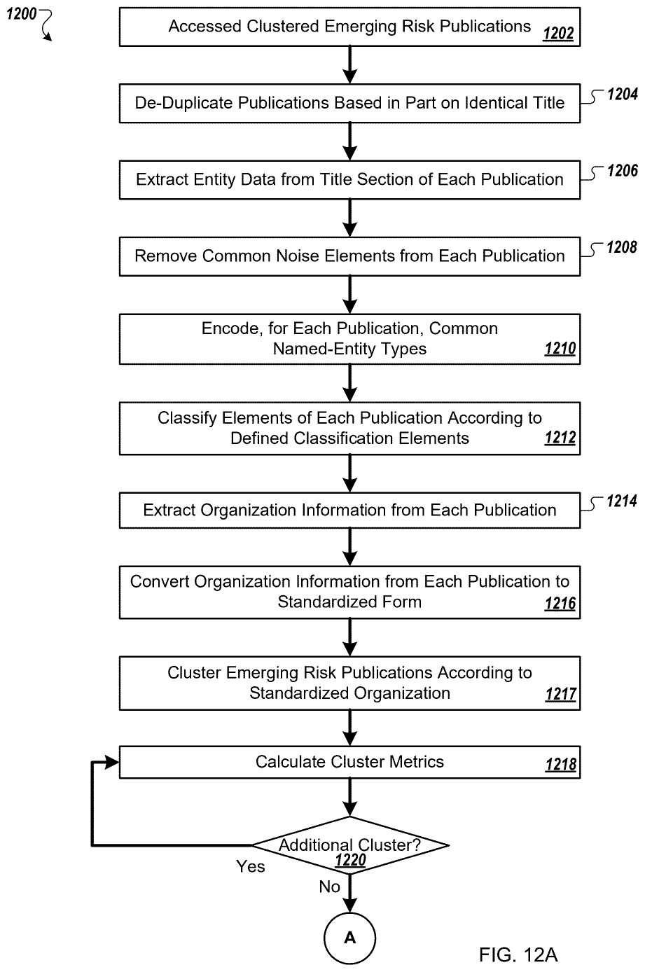

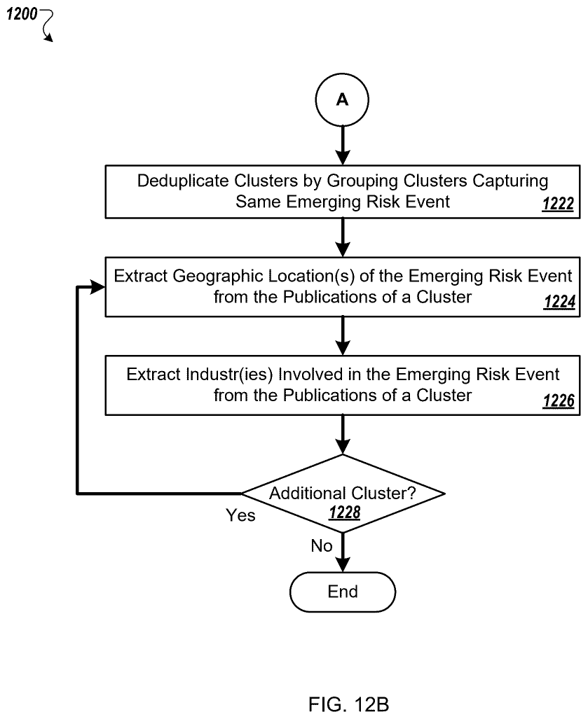

FIG. 12A and FIG. 12B illustrate a flow chart of an example method 1200 for preparing emerging risk publications for analysis. The method 1200, for example, may be performed on the publication data 1002 prior to access by the section extraction engine 1004 and/or at least in part by the named-entity recognition engine 1008 of FIG. 10. Portions of the method 1200, for example, may be performed by the publication extraction engine 103, publication analyzing engine 104, and/or event classifying engine 126 of FIG. 1A. Further portions of the method 1200 may be performed on the classified emerging risk event data 130 by the event data clustering engine 202 and/or on the clustered risk event data 204 by the cluster analysis engine 205 of FIG. 2.

In some implementations, the method 1200 begins with accessing clustered emerging risk publications (1202). The publications, in one example, may be initially clustered based on query contents used to collect the emerging risk publications. The queries to access the publications, for example, may include terms, classifications, and other organizational structure used to classify the response documents. In collecting the emerging risk publications, for example, a hierarchical set of queries may be performed against one or more news-related sources to procure documents responsive to a defined emerging risk, where query tokens are selected in part to identify, from a corpus of articles, those most likely to relate to a target emerging risk (e.g., a risk in one of the risk categories 1102 discussed in relation to FIG. 11). In additional examples, the emerging risk publications may be initially clustered by a news collection application programming interface (API) service and/or categorizations applied by one or more news sources. The clustered emerging risk publications may be accessed from a data storage region. The clustered emerging risk publications may have been stored to the data storage region responsive to running one or more queries to identify articles related to one or more different types of emerging risk events. The clustered emerging risk publications, for example, may be accessed from the emerging risk article data store 105 of FIG. 1A.

In some implementations, the emerging risk publications are de-duplicated based at least in part on identical article title. For each cluster, for example, duplicate articles having same title information and/or title and other information (e.g., author, word count, etc.) may be removed from further processing.

In some implementations, entity data is extracted from a title section of each emerging risk publication (1206). The entity data, for example, may include details regarding any major named-entity type (e.g., organization name, geographic location, monetary amount, etc.). The entity data may be stored to a named-entity recognition data set, such as the publication data 1002 of FIG. 10 or an interim version thereof. The named-entity recognition engine 1008, for example, may extract, from the publication text by section data 1006, named entities from the title section of each publication of the publication data 1002.

In some implementations, common noise elements are removed from each publication (1208). The elements, in some examples, can include website addresses, author names, and/or article upload timestamps.

In some implementations, common named-entity types are encoded for each publication (1210). The common named-entity types, in some examples, can include monetary values, geographic locations, and/or corporate organizations. The common named-entity types may be encoded within each publication (e.g., as metadata) and/or stored separately (e.g., as a part of the named-entity recognition data set populated with title information at operation 1206). The common named-entity types may be encoded, in some examples, by the publication analyzing engine 104 of FIG. 1A and/or the entity refining engine 214 of FIG. 2.

In some implementations, elements of each publication are classified according to defined classification elements (1212). One or more named-entity recognition (NER) classifiers, natural language processing (NLP) classifiers, and/or machine learning classifiers, for example, may parse at least a portion of the sections of each publication, such as the body text section, to classify portions of the text as noise. The classifiers, for example, may be trained using labeled data identifying common sections of documents and/or commonly included phrases as noise. Certain classifiers may be trained, for example, in view of a particular type of emerging risk event and/or category of emerging risk event to recognize elements specific to the risk event associated with the publication. The classifiers may allocate a probability associated with each classification. The classifications may be encoded within each publication (e.g., as metadata) and/or stored separately (e.g., as a part of the named-entity recognition data set populated with title information at operation 1206). The elements may be classified, in some examples, by the publication analyzing engine 104 of FIG. 1A and/or the entity refining engine 214 of FIG. 2.

In some implementations, organization information is extracted from each publication (1214). The organization information, in some examples, can be in the form of corporate identities in short (e.g., “Acme”) or in full (e.g., “Acme Corporation”) and/or stock ticker identifiers. The organization information may be extracted using one or more NER classifiers, NLP classifiers, and/or machine learning classifiers designed to recognize organization references. The organization information may be encoded within each publication (e.g., as metadata) and/or stored separately (e.g., as a part of the named-entity recognition data set populated with title information at operation 1206). The organization information may be extracted, in some examples, by the publication analyzing engine 104 of FIG. 1A and/or the entity refining engine 214 of FIG. 2.

In some implementations, the organization information from each publication is converted to a standardized form (1216). Any stock ticker information, for example, may be converted to the corporate name. Partial references of corporate organizations and/or nicknames for organizations may be expanded to the full formal name (e.g., including “Incorporated,” “Inc.,” “Corporation,” etc.). The organization registration/validation engine 110 of FIG. 1B, for example, may standardize the organization information using the organizational structure source(s) 111. In another example, the entity refining engine 214 of FIG. 2 may standardize the organization information as stored to the emerging risk cluster data 210. The standardized organization information may be encoded within each publication (e.g., as metadata) and/or stored separately (e.g., as a part of the named-entity recognition data set populated with title information at operation 1206).

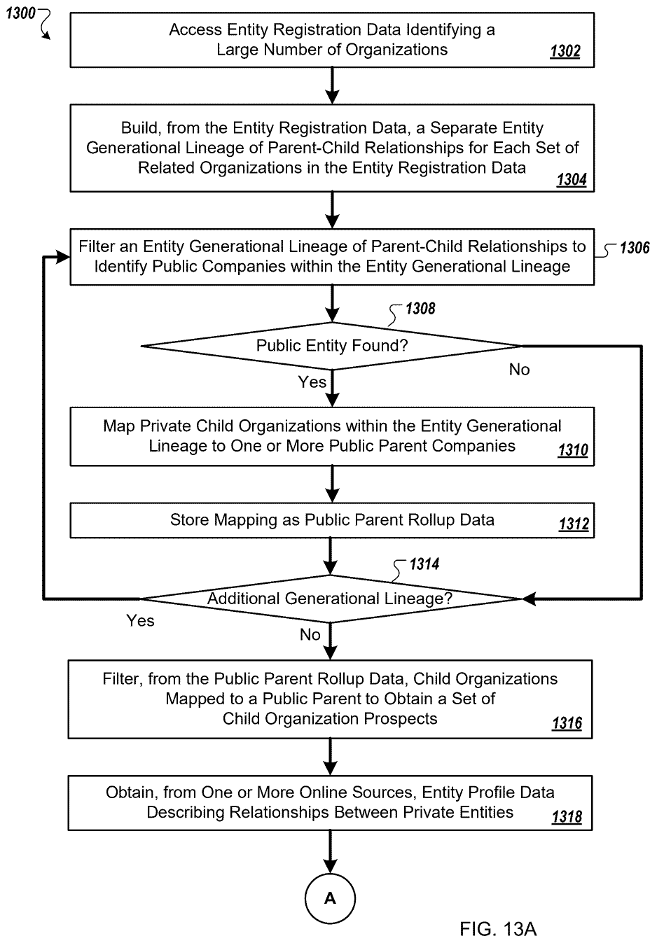

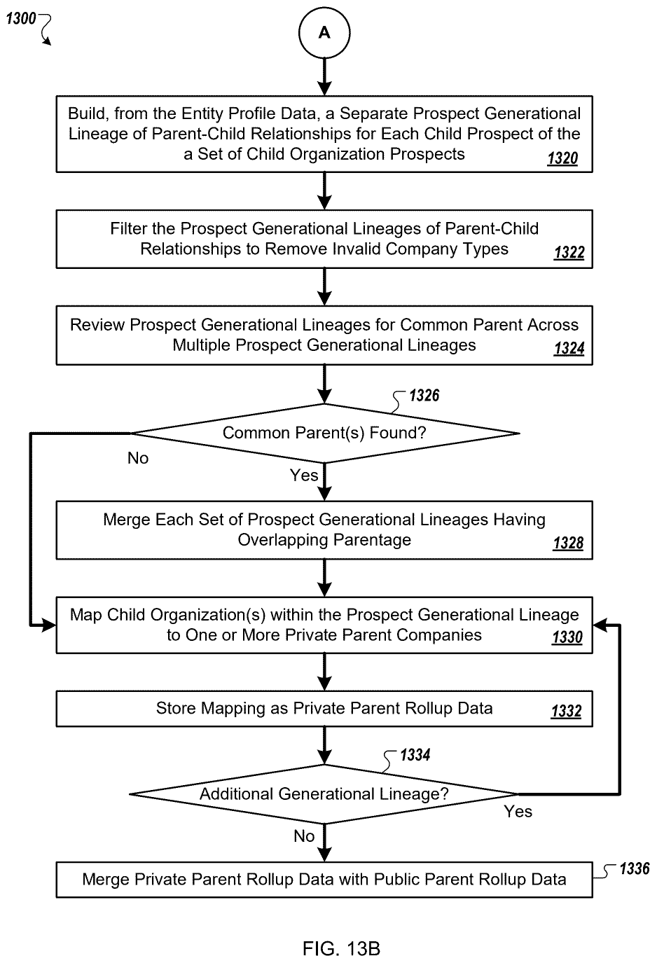

In some embodiments, organization information referencing subsidiaries of larger organizations is rolled up to identify the parent or umbrella organization. The subsidiary organization, for example, may be a private entity while the parent organization is a public entity. In other embodiments, private subsidiary organizations may be rolled up to identify the parent private organization. An example method 1300 for rolling up subsidiary organization information to a parent organization is described below in relation to FIG. 13A and FIG. 13B.

In some implementations, the emerging risk publications are clustered according to the standardized organization information (1217). Clustering may merge publications from multiple prior (initial) clusters. For example, a portion of publications may name a subsidiary alone while another portion names both the subsidiary and the parent organization and a further portion names only the parent organization. By standardizing the organization prior to re-clustering, all possible references to the effected organization may be collected together. The clustering may be based further, in some embodiments, on additional named-entity types 1210, such as the geographic location and/or details of the risk event.

In some implementations, cluster metrics are calculated (1218) for each publication cluster (1220). The cluster metrics, in some examples, can include a count of publications within each cluster, one or more start dates relevant to the emerging risk event of each cluster, and/or one or more end dates relevant to the emerging risk event of each cluster. The cluster metrics may be stored in relation to each cluster of publications. The cluster analysis engine 205 of FIG. 2, for example, may calculate the cluster metrics and store them as cluster metrics data 207.

Turning to FIG. 12B, in some implementations, the clusters are deduplicated by grouping clusters describing the same event (1222). Using the named-entity elements identified through operations 1206, 1210, 1214, and/or 1216, for example, the clusters may be compared to recognize clusters representing the same event. In illustration, one set of publications may have mentioned a private subsidiary while the other set of publications mentioned the public umbrella organization such that, upon rolling up the organizations to a common parent, the correspondence between multiple clusters became apparent. In another example, the cluster metrics calculated at operation 1218 (e.g., the start date(s), end date(s), etc.) may be used to recognize clusters of publications describing the same emerging risk event. In grouping clusters, for example, certain luster metrics such as count of publication may be aggregated to describe the new, grouped cluster. The cluster refining engine 212 of FIG. 2, for example, may aggregate clusters and store the grouped cluster information as the emerging risk cluster data 210.

In some implementations, geographic locations are extracted from the publications of a given cluster (1224). The geographic locations may differ across publications when an emerging risk impacts multiple regions. For example, a cyber attack may impact computing systems of an organization spanning multiple physical locations, potentially in multiple countries. By extracting geographic locations from the publications of the cluster, all potentially impacted locations may be identified. Further, counts of mentions each named geographic location, in some embodiments, are calculated across the set of publications within the cluster. The geographic locations may be stored in relation to the cluster data. For example, the cluster analysis engine 205 or the cluster refining engine 212 may store the identified geographic locations (and, potentially, counts of mentions associated therewith) as the emerging risk cluster data 210.

In some embodiments, similar to standardizing the corporate organization identifier, one or more location identifiers may be refined and/or rolled up to a coarser level of distinction. In illustration, an article may only mention a common city name (e.g., Dallas, Boston, etc.) without noting the corresponding state, such that the location information may be formalized to include both city and state representations. Further, an article presented in a particular state (e.g., a New Hampshire publication) may mention a common city name in that state (e.g., Salem) without noting the particular state, despite “Salem” being more commonly associated with the neighboring state of Massachusetts. In this example, the state of New Hampshire may be inferred based on the geographic jurisdiction of the news source. Where specific cities are noted, the city may be rolled up in coarseness to the corresponding county. For example, oftentimes publications will discuss events that occurred in “Minneapolis” when the actual event took place in a close suburb to the urban city of Minneapolis. In this illustration, some publications in the cluster may note the suburb while others generalize to Minneapolis, such that rolling the location up to the corresponding county will allow the location to be standardized across publications. Further, the information may be expanded to capture multiple levels of coarseness (e.g., “Los Angeles” becomes Los Angeles, Los Angeles County, California, USA). One or more natural language processing classifiers and/or machine learning classifiers, for example, may be trained to re-categorize jurisdictions. The classifiers, for example, may note a confidence level in each geographic location identified as well as a reference to the source used in making the identification. The geographic location identifiers, for example, may be stored to the emerging risk cluster data 210 (e.g., being identified the cluster analysis engine 205 or the cluster refining engine 212).

In some implementations, one or more industries involved in the merging risk event are extracted from the publications of a given cluster (1226). Industry information may be located in one or more publications of the cluster, for example, using one or more natural language processing classifiers and/or machine learning classifiers trained to recognize references to industries. The classifiers, for example, may note a confidence level in each industry identified as well as a reference to the source used in making the identification. Some publications may fail to mention an industry. Further, depending on the audience of a given publication, a certain industry or industries may be highlighted, despite the emerging risk event impacting multiple industries. Thus, in reviewing across the entire cluster, all impacted industries may be discerned. The industry identifiers, for example, may be stored to the emerging risk cluster data 210 (e.g., being identified the cluster analysis engine 205 or the cluster refining engine 212).

In some implementations, the method 1200 repeats (1228) operations 1224 and 1226 for all publication clusters.

Although described as a particular set of operations, in other embodiments, the method 1200 may include more or fewer operations. For example, a human-in-the-loop operation may be provided to confirm classifications of entities, for example where one or more geographic classifiers (operation 1224) and/or industry classifiers (operation 1226) were identified with less than a threshold level of confidence. In another example, rather than accessing clustered emerging risk publications 1202, in some embodiments, no initial clustering information is known regarding a collection of publications. In illustration, the collection of publications may only have information associated with a query used to retrieve them (e.g., a timestamp and a target emerging risk event type). Although described as a series of operations, in other embodiments, certain operations may be performed in a different order and/or a portion of the operations of the method 1200 may be performed at least partially concurrently. For example, the cluster metrics may be calculated (1218) after deduplicating the clusters (1222). Further, the geographic locations and the industries may be extracted (1224, 1226) at least partially concurrently from the publications. Other modifications to the method 1200 may be made.

FIG. 13A and FIG. 13B illustrate an example method 1300 for producing a mapping of child organizations to parent organizations. The method 1300, for example, may be performed by the organization registration/validation engine 110 of FIG. 1B and/or the entity refining engine 214 of FIG. 2.

Turning to FIG. 13A, in some implementations, the method 1300 begins with accessing entity registration data identifying a large number of organizations (1302). The entity registration data, for example, may be accessed from one or more business information sources, such as governmental registration sources (e.g., U.S. Securities and Exchange

Commission (SEC) data), business market insights platforms (e.g., S&P Global), and/or other informational sources (e.g., Wikidata). The entity registration data may include public companies and their subsidiaries. The entity registration data, for example, may be accessed by the organization registration/validation engine 110 of FIG. 1B from the organizational structure source(s) 111.

In some implementations, a separate entity generational lineage of parent-child relationships is built for each set of related organizations in the entity registration data (1304). The generational lineage, for example, may include a branched linkage of organizations according to relationships identified in the entity registration data. The generational lineage, for example, may include organization names, type of relationship (e.g., wholly owned subsidiary, partially owned subsidiary, joint venture, etc.), C-suite members of each organization (e.g., CEO, CTO, CSO, CFO, etc.), headquarters of each organization, stock ticker identifier, sector(s), industry(ies), and/or incorporation jurisdiction of at least a portion of the organizations of the lineage (e.g., as known and/or as applicable). Conversely, if the entity registration data may be formed of information accessed from one or more third party sources and combined to include many of the above-noted details regarding each organization.

In some implementations, an entity generational lineage of parent-child relationships is filtered to identify one or more public companies within the entity generational lineage (1306). The public companies, for example, may be referenced within the entity generational lineage itself. For example, the organization type may have been captured from the entity registration data. In another example, a registry of public companies may be searched for each company identified in the entity generational lineage.

If a public entity is found within the entity generational lineage (1208), in some implementations, private child organizations within the entity generational lineage are mapped to one or more of the public entities (1310). Each private child organization, for example, may be logically linked to the public parent organization such that, upon referencing the entity generational lineage, the public organization may be discovered. Multiple public entities may be involved, for example, in the circumstance of a joint venture.

In some implementations, the mapping is stored as public parent rollup data (1312). The public parent rollup data, for example, may be stored in a database form or other relational data structure for referencing child organization names to discover the public parent information.

In some implementations, the method 1300 continues to filter each entity generational lineage (1306) for public companies for all entity generational lineages built at operation 3104 (1314).

In some implementations, child organizations mapped to public parents are filtered from the public parent rollup data to obtain a set of child organization prospects (1316). The child organizations without a related public parent, for example, may be related to a larger umbrella organization that is not captured within public corporation documents (e.g., a private parent organization).

In some implementations, entity profile data describing relationships between private entities is obtained from one or more online sources (1318). The sources, for example, may include business and/or general information sources accessible online, such as Wikidata. The information, for example, may be accessed using the name of each child organization prospect.

Turning to FIG. 13B, in some implementations, a separate prospect generational lineage of parent-child relationships is built for each child prospect of the set of child organization prospects (1320). The prospect generational lineages may be built, for example, in a manner similar to that described in relation to building the entity generational lineages at operation 1304 of FIG. 13A.

In some implementations, the prospect generational lineages of parent-child relationships are filtered to remove any invalid company types (1322). The invalid company types, in some examples, may include investment banks, holding companies, and/or other organizations that include a financial interest in the organizational structure without actively controlling organization(s) within the structure.

In some implementations, the set of prospect generational lineages built at operation 1320 are reviewed to identify a common parent entity across two or more of the prospect generational lineages (1324). The common parent(s) may not each be a top listed organization within the lineage. For example, one lineage may be a partial extension of another lineage.

In some implementations, if common parents are found within two or more of the prospect generational lineages (1326), each set of prospect generational lineages having overlapping parentage are merged (1328). If one prospect generational lineage is a duplicate of a portion of another prospect generational lineage, the duplicate may be removed. If one prospect generational lineage includes additional organizations within the lineage, the two lineages may be combined to a larger prospect generational lineage.

In some implementations, one or more child organizations within the prosect generational lineage are mapped to one or more private parent companies (1330). Each private child organization, for example, may be logically linked to the private parent organization such that, upon referencing the entity generational lineage, the parent organization may be discovered. Multiple parent entities may be involved, for example, in the circumstance of a joint venture.

In some implementations, the mapping is stored as private parent rollup data (1332). The private parent rollup data, for example, may be stored in a database form or other relational data structure for referencing child organization names to discover the umbrella or parent information.

The method 1300, in some implementations, continues to map child organizations (1330) within each additional prospect generational lineage (1334).

In some implementations, once all of the prospect generational lineages include child-parent mappings (1334), the private parent rollup data is merged with the public parent rollup data (1336). The private and parent rollup data, for example, may be stored in a same database or other relational data storage region. In some embodiments, the private parent rollup data is added to the entity registration data.

Although described as a particular set of operations, in other embodiments, the method 1300 may include more or fewer operations. For example, if the entity registration data is locally stored, the public parent rollup data stored at operation 1312 may be used to update the information within the entity registration data. The entity registration data, in this circumstance, may be used to convert the organization information to standardized form, as described at operation 1216 of the method 1200 of FIG. 12A. Although described as a series of operations, in other embodiments, certain operations may be performed in a different order and/or a portion of the operations of the method 1300 may be performed at least partially concurrently. For example, parallel processing may be applied to perform the mappings of the private organizations to public parent companies (operations 1306-1314) and/or the mappings of private organizations to private parent companies (operations 1330-1334). In another example, all entity generational lineages may be filtered (1306) and those with public entities may be mapped in serial, parallel, or otherwise concurrently. Other modifications to the method 1300 may be made.

Reference has been made to illustrations representing methods and systems according to implementations of this disclosure. Aspects thereof may be implemented by computer program instructions. These computer program instructions may be provided to a processor of a general-purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer. The processing circuitry and stored instructions may enable the computing device to perform, in some examples, the process 100 of FIG. 1A, the process 120 of FIG. 1B, the process 200 of FIG. 2, the process 300 of FIG. 3, the method 400 of FIG. 4A through FIG. 4C, the method 600 of FIG. 6, the process 1000 of FIG. 10, the method 1200 of FIG. 12A and FIG. 12B, and/or the method 1300 of FIG. 13A and FIG. 13B.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the publication extraction engine 103 and the content sources 106 of FIG. 1A, the organization registration/validation engine 110 of FIG. 1B and the organizational structure source(s) 111 and/or the financial data source(s) 118, the entity data analyzing engine 116 of FIG. 1B and the financial data source(s) 118, the market value engine 322 of FIG. 3 and the financial data source(s) 118, and/or the manual review engine 1038 and the reviewer computing device 1042 of FIG. 10.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of the screen shots illustrated, in some examples, in FIG. 7A through FIG. 7C, FIG. 8A, FIG. 8B, and/or FIG. 9.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

In some implementations, a cloud computing environment, such as Google Cloud Platform™ or Amazon™ Web Services (AWS™), may be used perform at least portions of methods or algorithms detailed above. The processes associated with the methods described herein can be executed on a computation processor of a data center. The data center, for example, can also include an application processor that can be used as the interface with the systems described herein to receive data and output corresponding information. The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. For example, the emerging risk article data 105 and/or the classified events 130 of FIG. 1A, the event entity data 122 of FIG. 1B, the emerging risk cluster data 210 of FIG. 2, the reputational risk data 310 of FIG. 3, the cybersecurity event data 520, the event data 502, the entity data 530, and/or the financial snapshot data 540 of FIG. 5, and/or the publication data 1002, the event data 1024, the emerging risk schema 1034, and/or the emerging risk event details 1036 of FIG. 10 may be maintained in a database structure.

The systems described herein may communicate with the cloud computing environment through a secure gateway. In some implementations, the secure gateway includes a database querying interface, such as the Google BigQuery™ platform or Amazon RDS™. The data querying interface, for example, may support access by the publication extraction engine 102 of FIG. 1A to the content sources 106, access by the organization registration/validation engine 110 of FIG. 1B to the organizational structure source(s) 111 and/or the financial data source(s) 118, access by the entity data analyzing engine 116 of FIG. 1B to the financial data source(s) 118, and/or access by the market value engine 322 of FIG. 3 to the financial data source(s) 118.

In some implementations, an edge server is used to transfer data between one or more computing devices and a cloud computing environment according to various embodiments described herein. The edge server, for example, may be a computing device configured to execute processor intensive operations that are sometimes involved when executing machine learning processes, such as the publication analysis operations performed by the NLP model(s) 107 of FIG. 1A, the event classifying operations performed by the NLP model(s) 109 by FIG. 1A, the event data clustering operations performed by the NLP model(s) 206 and/or the AI 208 of FIG. 2, the entity refining operations performed by the AI 216 of FIG. 2, and/or the NLP model(s) 1030 of FIG. 10. An edge server may include, for example, one or more GPUs that are capable of efficiently executing matrix operations as well as substantial cache or other high-speed memory to service the GPUs. An edge server may be a standalone physical device. An edge server may be incorporated into other computing equipment, such as a laptop computer, tablet computer, medical device, or other specialized computing device. Alternatively or additionally, an edge server may be located within a carrying case for such computing equipment. An edge server, in a further example, may be incorporated into the communications and processing capabilities of a mobile unit such as a vehicle or drone, or may otherwise be located within the mobile unit.

In some implementations, the edge server communicates with one or more local devices to the edge server. The edge server, for example, can be used to move a portion of the computing capability traditionally shifted to a cloud computing environment into the local environment so that any computation intensive data processing and/or analytics required by the one or more local devices can run accurately and efficiently. In some embodiments, the edge server is used to support the one or more local devices in the absence of a connection with a remote computing environment. The edge server may be configured to communicate with the one or more local devices directly or via a network. For instance, the edge server can include a private wireless network interface, a public wireless network interface, and/or a wired interface through which the edge server can communicate with the one or more local devices. In some embodiments, certain local devices may be configured to communicate indirectly with the edge server, for example via another local device. Further, the edge server may be configured to communicate with a remote computing (e.g., cloud) environment via one or more public or private wireless network interfaces.

In some implementations, the publication extraction engine 103, the publication analyzing engine 104, and/or the event classifying engine 126 of FIG. 1A, the organization registration/validation engine 110 and/or the entity data analyzing engine 116 of FIG. 1B, the event data clustering engine 202, the cluster analysis engine 205, the entity refining engine 214, and/or the cluster refining engine 212 of FIG. 2, and/or the secondary risk assessment scheduling engine 302, the market value engine 322, the market prices adjustment engine 312, the financial transform engine 316 of FIG. 3, and/or the section extraction engine 1004, the named-entity recognition engine 1008, the semantic similarity analysis engine 1012, the top publications selection engine 1016, the publication information extraction engine 1020, the event-related publication analysis engine 1026, the manual review engine 1038, and/or the AI updating engine 1048 may be configured to be performed in part by an edge server or a device interoperating with an edge server. The device interoperating with the edge server, for example, may share processing functionality with the edge server via one or more APIs implemented by the processes.

The systems described herein may include one or more artificial intelligence (AI) neural networks for performing automated analysis of data. The AI neural networks, in some examples, can include a synaptic neural network, a deep neural network, a transformer neural network, and/or a generative adversarial network (GAN). The AI neural networks may be trained using one or more machine learning techniques and/or classifiers such as, in some examples, anomaly detection, clustering, and/or supervised and/or association. In one example, the AI neural networks may be developed and/or based on a bidirectional encoder representations for transformers (BERT) model by Google of Mountain View, CA.

The systems described herein may communicate with one or more foundational model systems (e.g., artificial intelligence neural networks). The foundational model system(s), in some examples, may be developed, trained, tuned, fine-tuned, and/or prompt engineered to evaluate data inputs such as the inputs described as being provided by the publication analyzing engine 104 of FIG. 1A, the event classifying engine 126 of FIG. 1A, the event clustering engine 202 of FIG. 2, the entity refining engine 214 of FIG. 2, the event-related publication analysis engine 1026 of FIG. 10, and/or the AI updating engine 1048 of FIG. 10. The foundational model systems, in some examples, may include or be based off of the generative pre-trained transformer (GPT) models available via the OpenAI platform by OpenAI of San Francisco, CA (e.g., GPT-3, GPT-3.5, and/or GPT-4) and/or the generative AI models available through Azure OpenAI or Vertex AI by Google of Mountain View, CA (e.g., PaLM 2).

Certain foundational models may be fine-tuned as AI models trained for performing particular tasks required by the systems described herein. Training material, for example, may be submitted to certain foundational models to adjust the training of the foundational model for performing types of analyses described herein.

Multiple foundational model systems may be applied by the systems and methods described herein depending on context. The context, for example, may include type(s) of data, type(s) of response output desired (e.g., at least one answer, at least one answer plus an explanation regarding the reasoning that lead to the answer(s), etc.). In another example, the context can include user-based context such as demographic information, entity information, and/or product information. In some embodiments, a single foundational model system may be dynamically adapted to different forms of analyses requested by the systems and methods described herein using prompt engineering.

While certain embodiments have been described, these embodiments have been presented by way of example only and are not intended to limit the scope of the present disclosure. Indeed, the novel methods, apparatuses and systems described herein can be embodied in a variety of other forms; further, various omissions, substitutions and/or changes in the form of the methods, apparatuses and systems described herein can be made without departing from the spirit of the present disclosure. The accompanying claims and their equivalents are intended to cover such forms or modifications as would fall within the scope and spirit of the present disclosure.

What is claimed is:

1. A system for automatically collating information from a corpus of publications regarding effects of an emerging risk on at least one organization, the system comprising:
a set of queries stored to at least one non-transitory computer-readable medium, the set of queries comprising, for each respective emerging risk event type of a plurality of emerging risk event types, one or more queries configured to obtain a plurality of publications relevant to the respective emerging risk event type, wherein
the plurality of emerging risk event types comprises two or more of environmental risks, health risks, cybersecurity risks, and geopolitical risks;
one or more natural language classifiers stored to the at least one non-transitory computer-readable medium, each natural language classifier of the one or more natural language classifiers trained to identify, within text describing at least one emerging risk event type of the plurality of emerging risk event types, a set of named-entity values comprising an organization name and a geographic region;
an event vector database;
one or more artificial intelligence (AI) networks fine-tuned to extract emerging risk event details from publication text; and
processing circuitry configured to
submit the one or more queries of a given emerging risk event type of the plurality of emerging risk types to one or more query-searchable content sources to collect a plurality of digital resources relevant to the given emerging risk event type,
analyze the plurality of digital resources using at least one of the one or more natural language classifiers relevant to the given emerging risk event type to identify the set of named-entity values,
convert the organization name of each digital resource of the plurality of digital resources to a standardized form,
using the set of named-entity values, cluster subsets of the plurality of digital resources as belonging to a same emerging risk event of a set of emerging risk events, and
for each cluster subset of the cluster subsets of the plurality of digital resources,
determine one or more counts of named-entity values within each digital resource of the plurality of digital resources,
classify a depth of information of each digital resource of the plurality of digital resources based at least in part on the one or more counts,
compare the plurality of digital resources according to semantic similarity to define groups of similar digital resources of the plurality of digital resources,
based on the groups of similar digital resources and the depth of information of each of the plurality of digital resources, select a representative set of digital resources of the plurality of digital resources including a representative publication of each respective group of the groups of similar digital resources, the representative publication comprising a threshold depth of information in view of the respective group of digital resources,
for each respective digital resource of the representative set of digital resources, transform at least a portion of text of the respective digital resource into a respective subset of vector-formatted text portions of a plurality of vector-formatted text portions,
store, to the event vector database, the plurality of vector-formatted text portions, wherein at least a portion of the plurality of vector-formatted text portions are arranged in the event vector database by named-entity values encoded within the portion of the plurality of vector-formatted text portions,
prompt at least one AI network of the one or more artificial intelligence networks to extract a set of emerging risk event details from the plurality of vector-formatted text portions, wherein the set of emerging risk event details comprise a start date, an end date, and a descriptive headline, and
store the set of emerging risk event details as event data in an event data relational storage structure.

2. The system of claim 1, wherein the set of queries comprises, for each respective emerging risk event type of at least a portion of the plurality of emerging risk event types, a first query directed to a first subtype of the emerging risk type, and a second query directed to a second subtype of the emerging risk type.

3. The system of claim 1, wherein the one or more natural language classifiers comprise at least one natural language processing algorithm.

4. The system of claim 1, wherein the set of named-entity values further comprises at least one of a dollar amount, a product, or a person of leadership within the organization identified by the organization name.

5. The system of claim 1, wherein a number of the representative set of digital resources is under fifty.

6. The system of claim 1, wherein the one or more artificial intelligence networks are large language models.

7. The system of claim 1, wherein the set of emerging risk event details further comprise at least one of an impact value, one or more product names, or a geographic expanse of impact.

8. The system of claim 1, further comprising the event data relational data structure, wherein:
the event data relational data structure comprises
an event data structure configured to store a set of event data values comprising the start date, the end date, the organization name, and the geographic region,
an entity data structure configured to link to the event data structure by the organization name, and
a financial snapshot data structure configured to link to the entity data structure by the organization name; and
the processing circuitry is further configured to, for each respective cluster subset of the set of cluster subsets of the plurality of digital resources
capture, from one or more financial data sources, a current valuation for an organization described by the organization name of the respective cluster subset, and
store the current valuation to the financial snapshot data structure.

9. The system of claim 8, wherein the financial snapshot data structure comprises a stock price, a stock market index price, and a capture date.

10. The system of claim 8, wherein the processing circuitry is further configured to, based on the given emerging risk event type, classify each emerging risk event of the set of emerging risk events as having a reputational risk.

11. A system for monitoring secondary impact to an organization due to a risk event, the system comprising:
one or more natural language classifiers stored to the at least one non-transitory computer-readable medium, each natural language classifier of the one or more natural language classifiers trained to identify, within text describing at least one emerging risk event type of the plurality of emerging risk event types, at least one of an organization identifier and a location;
a non-transitory computer-readable data store configured to store event data for a plurality of monitored emerging risk events; and
one or more processors configured to perform operations comprising
gathering a plurality of publications relevant to an emerging risk event type,
analyzing text contents of each publication of the plurality of publications using the one or more natural language classifiers to identify, for each publication of the plurality of publications, a plurality of event data values, wherein the plurality of event data values comprises the one or more respective organization identifiers and the one or more respective locations,
based at least in part on the one or more respective organization identifiers and the one or more respective locations of each publication of the plurality of publications, grouping subsets of the plurality of publications into a set of publication clusters, wherein each respective publication cluster of the set of publication clusters belongs to a same risk event of a set of risk events of the emerging risk event type,
for each respective risk event of the set of risk events,
using the one or more organization identifiers, determine a dominant organization, and
initiating entity valuation monitoring to track potential risk impact, wherein the valuation monitoring comprises
using the dominant organization, collecting an initial financial snapshot using on a first date,
multiple days after the initial financial snapshot, collecting at least one additional financial snapshot of the dominant organization on a second date,
analyzing the at least one additional financial snapshot in view of the initial financial snapshot to determine an organizational financial trend over a post-event time period spanning from the first date to the second date,
using at least one beginning market snapshot of the first date and at least one ending market snapshot of the second data, determining at least one comparison financial trend over the post-event time period,
adjusting the organizational financial trend in view of the at least one comparison financial trend, and
analyzing the adjusted organizational financial trend to identify any evidence of a secondary risk financial impact to the organization due to a secondary risk.

12. The system of claim 11, wherein the emerging risk event type is one of a physical disruption risk, a digital disruption risk, a workforce volatility risk, a financial volatility risk, or a regulatory risk.

13. The system of claim 11, wherein the secondary impact risk is one of a reputational risk or a supply chain risk.

14. The system of claim 11, wherein the plurality of event data values further comprises one or more dates.

15. The system of claim 11, wherein the one or more processors are further configured to perform operations comprising, for each respective publication cluster of the plurality of publication clusters, using the plurality of event data values, review the plurality of monitored emerging risk events for a matching risk event, wherein
upon failing to identify the matching risk event, the plurality of event data values of the respective publication cluster are added as a new monitored emerging risk event of the plurality of monitored emerging risk events; and
upon identifying the matching risk event, the plurality of event data values are merged with the event data of the matching risk event of the plurality of monitored emerging risk events.

16. The system of claim 11, wherein the one or more processors are further configured to, prior to initiating the entity valuation monitoring:
based at least in part of a count of publications in a respective publication cluster of the set of publication clusters corresponding to the respective risk event, quantify a level of publicity for the respective risk event; and
based at least in part on the publicity level, determine a likelihood of reputational risk,
for each respective risk event of the set of risk events having the likelihood of reputational risk at or above a threshold level;
wherein the entity valuation monitoring is initiated responsive to determining the likelihood of reputational risk is at or above a threshold level.

17. The system of claim 11, wherein the at least one comparison financial trend comprises a market value trend using an industry of the organization.

18. A system for mapping subsidiary organizations to parent organizations, the system comprising:
a non-transitory computer-readable medium storing an entity registration data comprising, for a plurality of organizations, a plurality of mappings between a respective parent organization of the plurality of organizations and a respective subsidiary organization of the plurality of organizations, wherein
each organization of a subset of the plurality of organizations is identified, within the entity registration data, as a public company; and
processing circuitry configured to
build, from the plurality of mappings of the entity registration data, a plurality of entity generational lineages comprising, for each entity generational lineage of the plurality of entity generational lineages, one or more parent-child relationships among a plurality of lineage members, wherein
every lineage member of the plurality of lineage members belongs to at least one parent-child relationship of the one or more parent-child relationships,
for each respective entity generational lineage of the plurality of entity generational lineages,
filter the plurality of lineage members to identify any public company of the plurality of lineage members of the respective entity generational lineage, and
responsive to identifying at least one public company, map all remaining lineage members of the plurality of lineage members as a child organization to a respective public company of the at least one public company according to the one or more parent-child relationships within a respective set of public parent rollup data of a plurality of sets of public parent rollup data, and
using the plurality of sets of public parent rollup data, identify, within the plurality of organizations, a set of child organization prospects lacking a mapping to any public parent organization,
using the set of child organization prospects, obtain, from one or more online sources, entity profile data describing relationships between private entities,
build, from the entity profile data, a plurality of prospect generational lineages comprising, for each prospect generational lineage of the plurality of prospect generational lineages, one or more parent-child relationships among a plurality of prospect lineage members, wherein
every prospect lineage member of the plurality of prospect lineage members belongs to at least one parent-child relationship of the one or more parent-child relationships, and
each child organization prospect of the set of child organization prospects in included in a separate prospect generational lineage of the plurality of prospect generational lineages,
for each respective prospect generational lineage of the plurality of prospect generational lineages,
map, as a child organization to a main organization of the respective prospect generational lineage, each prospect lineage member of a remainder of the plurality of prospect lineage members within a respective set of private parent rollup data of a plurality of sets of private parent rollup data, and
merge the plurality of sets of private parent rollup data with the plurality of sets of public parent rollup data.

19. The system of claim 18, wherein the plurality of mappings of the entity registration data comprises a plurality of database relationship links.

20. The system of claim 18, wherein the processing circuitry is further configured to, prior to mapping each prospect lineage member:
review the plurality of prospect generational lineages for one or more common parents shared by two or more prospect generational lineages of the plurality of prospect generational lineages; and
merge all sets of prospect generational lineages of the plurality of prospect generational lineages having one or more common parents.

21. The system of claim 18, wherein:
each prospect lineage member of a portion of the plurality of prospect lineage members is associated with a respective organization type of a plurality of organization types; and
the processing circuitry is further configured to remove, from each prospect generational lineage of the plurality of prospect generational lineages, any invalid organization type of a set of invalid organization types.

22. The system of claim 18, wherein the set of invalid organization types comprises at least one financial organization type and at least one nonprofit organization type.
